(19) United States
(12) Patent Application Publication
(10) Pub. No.: US 2026/0082065 A1
(43) Pub. Date: Mar. 19, 2026

(54) SUB-TILE-BASED GRID SAMPLING IN NEURAL VIDEO CODECS

(71) Applicant: Intel Corporation, Santa Clara, CA (US)

(72) Inventors: Prashant Laddha, Bengaluru (IN); Om Ji Omer, Bangalore (IN); Arnab Raha, San Jose, CA (US); Deepak Abraham Mathaikutty, Chandler, AZ (US)

(73) Assignee: Intel Corporation, Santa Clara, CA (US)

(21) Appl. No.: 19/398,408

(22) Filed: Nov. 24, 2025

(51) Int. Cl. H04N 19/43; H04N 19/105; H04N 19/139; H04N 19/172; H04N 19/196; H04N 19/436; H04N 19/55

(52) U.S. Cl. CPC H04N 19/43; H04N 19/105; H04N 19/139; H04N 19/172; H04N 19/198; H04N 19/436; H04N 19/55

(57) ABSTRACT

Real-time neural video codecs face significant latency and energy bottlenecks due to pixel-level grid sampling, which requires irregular, fine-grained memory accesses and limits efficient hardware acceleration. To address this, a sub-tile-based grid sampling technique is disclosed herein. The technique determines super tile sizes using motion vector gradients, neural network parameters, and available on-chip memory. A super tile is split into sub-tiles by detecting motion boundaries through motion vector analysis, where a sub-tile has homogeneous motion vectors. For each sub-tile, a reference bounding box is computed to enable efficient block transfers of reference data, and per-pixel metadata is generated for feature interpolation. The pipelined, parallelizable solution reduces number of memory accesses and computational overhead, compared to existing pixel-based techniques.

### BACKGROUND

Neural networks (NNs), e.g., deep neural networks (DNNs), are used extensively for a variety of machine learning (ML) and artificial intelligence (AI) applications ranging from computer vision to speech recognition and natural language processing due to their ability to achieve high accuracy. Recently, DNNs are used in video codec applications for improved performance over traditional video codecs such as H.264. NNs in neural video codecs (NVCs) can capture spatial-temporal correlations/contexts more accurately than the traditional video codecs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates per-pixel grid sampling, according to some embodiments of the disclosure.

FIG. 2 illustrates non-homogeneous motion vector (MV) information at motion boundaries, according to some embodiments of the disclosure.

FIG. 3A illustrates a ratio of reference tile size with respect to output tile size, according to some embodiments of the disclosure.

FIG. 3B illustrates a reference bounding box for a tile with heterogenous motion vector information, according to some embodiments of the disclosure.

FIG. 4 illustrates a computing system for performing per-pixel operations, according to some embodiments of the disclosure.

FIG. 5 illustrates a process flow for sub-tile-based grid sampling and data used in the process flow, according to some embodiments of the disclosure.

FIG. 6 illustrates efficient data movement supporting sub-tile-based grid sampling, according to some embodiments of the disclosure.

FIG. 7 illustrates a process flow for sub-tile-based grid sampling including data movement stages, according to some embodiments of the disclosure.

FIG. 8 illustrates pipelining stages of sub-tile-based grid sampling, according to some embodiments of the disclosure.

FIGS. 9-11 illustrate splitting a super tile into one or more sub-tiles, according to some embodiments of the disclosure.

FIG. 12 illustrates calculating a memory index corresponding to reference data associated with a reference pixel in a reference bounding box, according to some embodiments of the disclosure.

FIGS. 13-14 illustrate metadata for a sub-tile, according to some embodiments of the disclosure.

FIG. 15 illustrates micro-architecture for motion vector analysis operations, according to some embodiments of the disclosure.

FIG. 16 illustrates a single cycle gradient calculator, according to some embodiments of the disclosure.

FIG. 17 illustrates components in a compute engine, according to some embodiments of the disclosure.

FIG. 18 depicts a flow diagram illustrating a method for performing feature vector interpolation in a multiply-and-accumulate array, according to some embodiments of the disclosure.

FIG. 19 depicts a flow diagram illustrating a method for sub-tile-based execution of grid sampling, according to some embodiments of the disclosure.

FIG. 20 depicts a flow diagram illustrating a method for sub-tile-based execution of grid sampling, according to some embodiments of the disclosure.

FIG. 21 depicts a block diagram of an exemplary computing device, according to some embodiments of the disclosure.

### DETAILED DESCRIPTION

NVCs are emerging as a major advancement over traditional video codecs, such as Advanced Video Coding (AVC or H.264), High Efficiency Video Coding (HEVC or H.265), and Versatile Video Coding (VVC or H.266). NVCs leverage NNs in one or more residual coding blocks to capture spatial-temporal correlations/contexts accurately. Some NVCs can outperform traditional video codecs in rate-distortion performance. Unlike traditional video codecs, which have limited options for evolution like additional block sizes and encoding modes, NVCs offer much higher flexibility and adaptability. And, given the strong representational power of NNs, NVCs are expected to advance more rapidly than traditional video codecs, accelerating their adoption across a wide range of applications, including applications in client and data center platforms.

Real-time deployment of existing NVCs on hardware presents significant challenges due to the computational and memory inefficiencies of pixel-level grid sampling. Unlike traditional video codecs, which employ block-based motion compensation and facilitate efficient block data transfers, NVCs require per-pixel feature vector interpolation. Dense motion compensation in NVC, which is also known as grid sampling, involves performing per-pixel sampling or interpolation of feature vectors at a location in reference frame grid. Grid sampling's per-pixel feature vector interpolation is challenging to accelerate on GPU or NPU architectures due to its fine-grained operations. In one experiment on an NPU, implementing grid sampling for a 1080p frame can take a few hundred milliseconds. Such a high grid sampling latency prohibits real-time deployment of NVCs on client/data center platforms. For example, NVCs use dense motion fields to transform pixel/residual data into high-dimensional feature space and perform motion compensation and residual coding in the feature domain. This results in scattered reference regions and irregular memory access patterns, leading to high grid sampling latency and increased energy consumption.

Attempts to perform block-based feature vector interpolation versus pixel-based feature vector interpolation can alleviate some of these issues. However, block-based feature vector interpolation can lead to higher residuals than pixel-based feature interpolation, which lower compression efficiency. While the multiple NN blocks and residual coding in the feature domain in NVC enables higher compression, working in the feature domain increases the computational complexity significantly as compared to traditional video codecs. Although the NN blocks in NVC can be accelerated by mapping them on hardware accelerators (e.g., graphics processing units (GPUs), neural processing units (NPUs), etc.) in modern system-on-chips (SoCs), mapping the dense motion compensation in NVC onto those hardware accelerators remains a challenge. In addition, block-based feature vector interpolation leads to blocking artifacts when adjacent blocks have different motion vector characteristics.

To address these limitations, a sub-tile-based grid sampling architecture is disclosed herein to improve over the grid sampling solutions provided by existing NVCs. In particular, the architecture aggregates per-pixel operations associated with grid sampling into rectangular sub-tiles and enabling the compute engine to perform grid sampling on a sub-tile basis. The sub-tiles are created in a way to have substantially homogeneous motion vector data. Aggregating the per-pixel operations into sub-tiles can reduce latency by enabling sub-tile-based execution of grid sampling efficiently from on-chip memory. Moreover, aggregating the per-pixel operations into sub-tiles can reduce latency by allowing efficient block data transfers of reference data associated with sub-tiles between off-chip memory and on-chip memory. Having similar motion vector data in a sub-tile means that the memory accesses from off-chip memory can be reduced by minimizing bounding box wastages and reusing shared reference pixels across neighboring pixels.

The sub-tile-based grid sampling architecture determines a super tile, which is a rectangular region of a video frame. Determining a super tile is to calculate a size of the super tile whose reference data is likely going to fit onto the on-chip memory. The size of the super tile can be determined, chosen, or selected based on one or more of: motion vector statistics, neural network parameters, and hardware memory constraints. The amount of reference data associated with a super tile can depend on factors such as the motion vector information in the super tile and parameters of neural network controlling the size of the feature vectors in the reference data. In some embodiments, the super tile size is determined based on the statistics (e.g., average gradients) of motion vectors for a super tile calculated for a previously processed frame. In some embodiments, the super tile size is determined based on the number of feature channels and precision of feature values controlled by the neural network architecture. In some embodiments, the super tile size is constrained by the available on-chip memory. This ensures that the reference data to calculate output data for a super tile fits within the hardware's memory limits.

Within the super tile, motion boundaries are detected, and the detected motion boundaries can be used to split the super tile into sub-tiles. Sub-tiles represent different rectangular regions of the super tile. In some embodiments, motion boundaries can be determined based on a gradient of motion vectors along a horizontal axis or direction and/or a gradient of motion vectors along a vertical axis or direction. Specifically, the gradient of motion vectors along a horizontal direction can be calculated by first summing the motion vectors across each row of the super tile, resulting in a row-wise sum-vector. The element-wise difference between adjacent entries in row-wise sum-vector is then computed to quantify the change in motion across the horizontal axis or direction. Similarly, the gradient of motion vectors along a vertical axis or direction can be determined by summing the motion vectors down each column to obtain a column-wise sum-vector. The element-wise difference between consecutive entries of the column-wise sum-vector is calculated to capture changes along the vertical axis or direction. These gradient computations are performed separately for both the x and y components of the motion vectors. After calculating the gradients for x- and y-components, the dominant gradient, i.e., those exhibiting the most significant changes, are selected for further analysis. Positions where these gradients exceed a configurable threshold are identified as motion boundaries. The super tile is split at these positions into a plurality of rectangular sub-tiles. This non-hierarchical splitting algorithm can ensure that motion vector information within a sub-tile is substantially similar or homogeneous. Doing so can reduce the dispersion of reference coordinates and reduce the size of each sub-tile's reference bounding box.

It is envisioned herein that a horizontal axis or direction identifies one of the two principal axes or directions in a two-dimensional frame, grid, or space, and a vertical axis or direction identifies the other one of the two principal axes or directions in the two-dimensional grid or space. The term horizontal or vertical does not imply a particular orientation or direction beyond distinguishing it from each other. Referring to horizontal and vertical means that the analysis or operation being described is performed along one axis and the other axis respectively, without suggesting a fixed or absolute orientation in the broader context of the frame, grid, or space.

In some embodiments, the sub-tile-based grid sampling architecture includes specialized instructions to find motion boundaries in a sub-tile. Examples of the specialized instructions in the instruction set can include MVTLSPLIT for motion vector tile splitting, VELGRAD for gradient calculation, and RCSUM for row and column sum computation. The instructions can trigger execution of the corresponding operations via dedicated microarchitectural blocks. The specialized instructions can also be used to cluster similar data together or divide data into sub-tiles where data within a sub-tile is substantially homogeneous, similar, or uniform. The specialized instructions can also be used to find boundaries where the data changes drastically, e.g., motion boundaries where motion vector data changes drastically.

For a sub-tile, a reference bounding box can be calculated to facilitate data movement of reference data for the sub-tile. The reference bounding box bounds the reference data within a rectangular region. The reference bounding box can be specified by one or more pixel coordinates, a width, and a height. In some embodiments, the reference bounding box can be calculated by tracking the minimum and maximum integer reference coordinates across all pixels in the sub-tile. This reference bounding box can be used to program efficient block data transfers and can ensure a minimal amount of reference data for sub-tile-based processing is loaded into on-chip memory.

The sub-tile-based grid sampling architecture further includes the calculation of per-pixel metadata for pixels in a sub-tile to facilitate accessing reference data and interpolation weights for pixel-based grid sampling. The per-pixel metadata can include a memory index, such as an integer coordinate, an index, or an offset, that points to reference data associated with a reference pixel in the reference bounding box for a given pixel in the sub-tile. The per-pixel metadata can include interpolation weights corresponding to one or more reference pixels in the reference bounding box for a given pixel in the sub-tile to enable pixel-based feature vector interpolation.

Metadata comprising the reference bounding box and per-pixel metadata for a sub-tile can be arranged and stored in a compact structure.

Leveraging the metadata, a compute engine can efficiently load reference data (e.g., four feature vectors) and apply the corresponding interpolation weights to perform per-pixel feature vector interpolation.

The compute engine, which may include an array of parallel multiply-and-accumulate (MAC) units, can produce output data for each pixel in the sub-tile. The data parallelism of the compute engine can be exploited to perform pixel-based grid sampling for many pixels in the sub-tile in parallel or to execute operations for multiple pixels of a sub-tile simultaneously.

In some embodiments, the overall process from super tile determination to writing output data of per-pixel grid sampling can be organized as pipelined stages, such as motion vector read, motion vector analysis, reference data load for a sub-tile, per-pixel feature vector interpolation for the sub-tile, and output write for the sub-tile. Staged pipelined execution of the stages can hide or mask the latency of motion vector analysis behind memory access and compute stages.

The sub-tile-based grid sampling architecture can leverage frame-to-frame stability in motion vector gradients. When these gradients remain stable between frames, prior statistics of motion vector information calculated for one or more previous frames can be reused for determining the super tile of the current frame. Moreover, when these gradients remain stable between frames, prior super tile size determined for one or more previous frames can be reused for a current frame, reducing overall analysis overhead.

The sub-tile-based grid sampling architecture can speed up grid sampling significantly, e.g., by many orders of magnitude, by reducing off-chip memory data transfers and enabling efficient block data transfer of reference data and sub-tile-based execution of grid sampling. The architecture can reduce the end-to-end codec latency drastically. In some scenarios, the off-chip memory data transfers are reduced by several orders of magnitude, which translates to execution speedup and energy savings. As a result, it is practical to deploy real-time NVCs on client and data center hardware platforms.

Furthermore, the aggregation and compaction of reference data to create rectangular clusters/tiles/partitions of data to facilitate compute and reduce memory accesses can be adaptable to other block-based data clustering and processing applications. In some examples, the technique can be used to create macro-block partitions having similar textures. In some examples, the technique can be used in block quantization to find rectangular blocks of data with similar magnitude and decide quantizer scale for the block.

Per-pixel grid sampling in NVCs and challenges

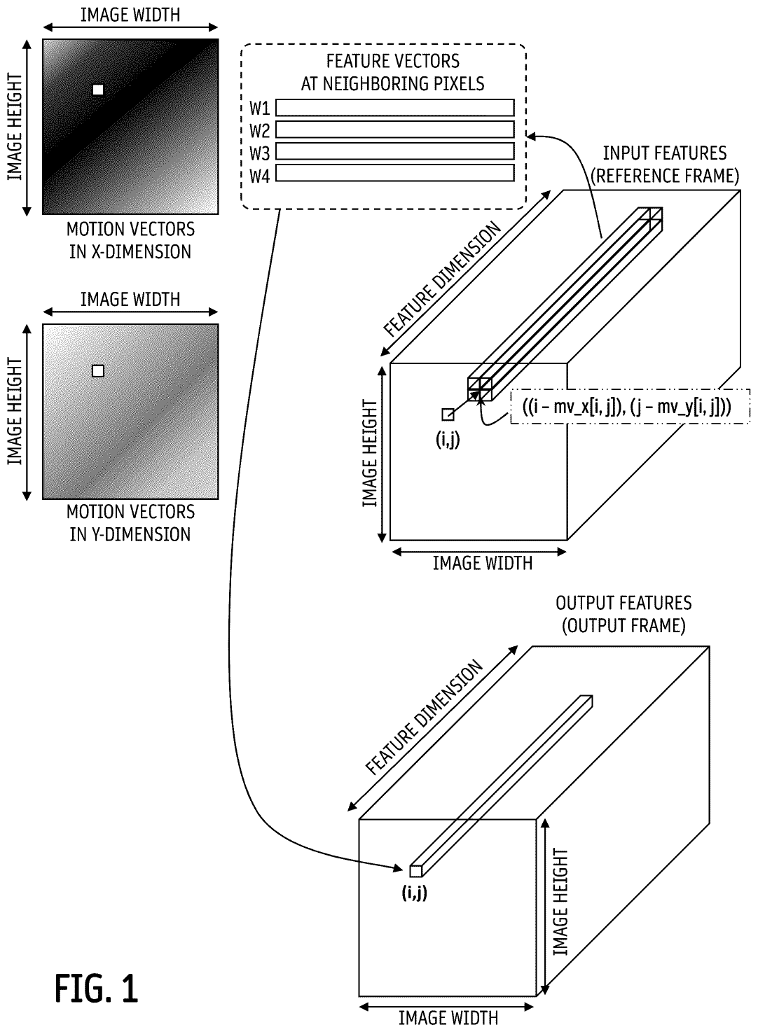

FIG. 1 illustrates per-pixel grid sampling, according to some embodiments of the disclosure. The output feature vector at each pixel (i,j) is interpolated from input feature vectors at four pixels surrounding the fractional pixel location in the reference frame pointed by motion vectors mv_x[i,j] and mv_y[i,j]. The fractional pixel location is denoted by ((i−mv_x[i, j]), (j−mv_y[i, j])). For each pixel located at coordinates (i, j), the output feature vector is determined through weighted interpolation of the input feature vectors from four pixels that surround the fractional pixel location in the reference frame ((i−mv_x[i, j]), (j−mv_y[i, j])). The weights are denoted by w1, w2, w3, and w4. This fractional location is specified by the motion vectors, mv_x[i,j] and mv_y[i,j] relative to the pixel location (i,j), which guide the sampling process. By referencing these four motion feature vectors, the architecture enables precise interpolation using the feature vectors associated with the nearest pixels in the reference frame, thereby supporting accurate per-pixel grid sampling and motion compensation within the feature domain.

In traditional video codecs, each rectangular block (tile) of pixels has a single motion vector, and corresponding reference region is rectangular. Therefore, the reference region can be fetched using a single block data transfer. In contrast, grid sampling, as illustrated in FIG. 1 operates at per-pixel granularity. Since each pixel has its own motion vector, the reference pixel locations and associated interpolation weights for input feature vectors are calculated, and feature vector reads/writes are triggered separately for each pixel. Such fine-grained data accesses in per-pixel grid sampling are significantly slower than block data transfers.

Processing at each pixel uses feature vectors from four reference pixels. If adjacent pixels are processed separately, the reference pixels which might be common to set of adjacent pixels are fetched again. This means that there is significant lack of reuse of reference data among adjacent pixels in per-pixel grid sampling.

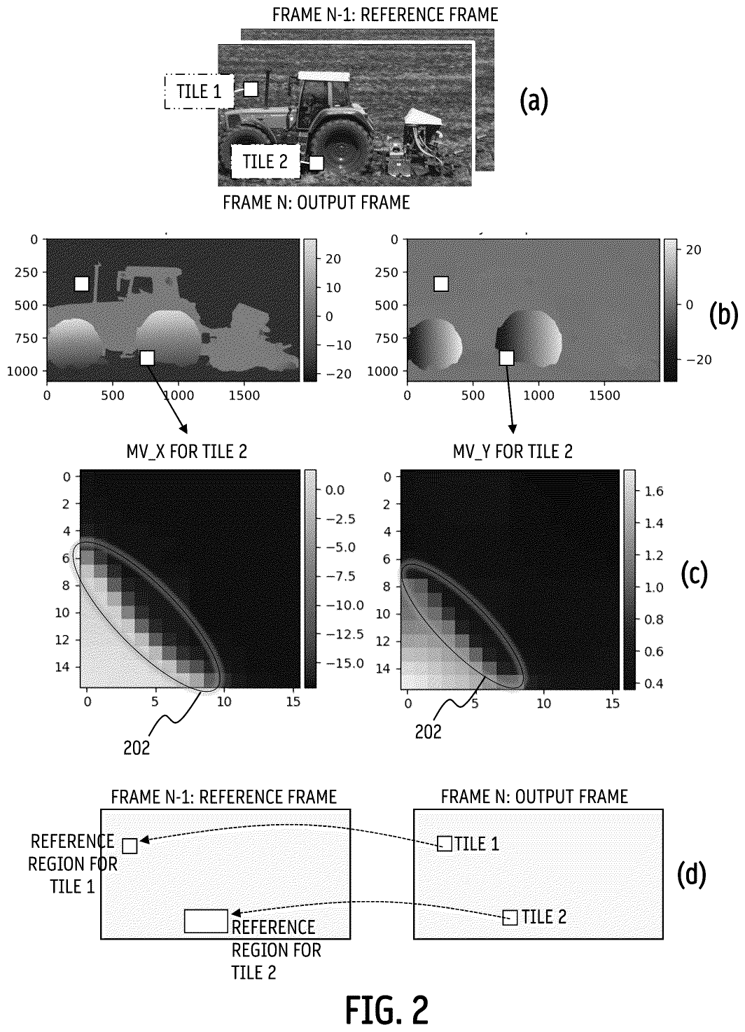

FIG. 2 illustrates non-homogeneous motion vector information at motion boundaries, according to some embodiments of the disclosure.

Part (a) of FIG. 2 illustrates video frames of a video. The video frames include an output frame, FRAME N (where N denotes the frame has a frame index that equals to N−1), and a reference frame, FRAME N−1 (where N−1 denotes that the frame has a frame index that equals to N−1).

In some implementations, the reference frame may not necessarily be the frame immediately before the output frame. For example, the reference frame may have a frame index of K, where K can be equal to N or different from N. The reference frame index K can represent various frames in a video sequence relative to the output frame index N. For instance, K could be equal to N, as in intra-frame prediction; K might be N−1, referring to the immediately preceding frame for inter-frame prediction; K could be a lower value such as 5 for referencing older frames in long-term scenarios; or K might be greater than N, like 15, which could indicate a future frame in bidirectional prediction. K may be any valid frame index, chosen based on the codec's prediction strategy.

The video depicts a tractor slowly driving to the left on a field while the tractor remains centered and framed on the video. Tile 1 of the output frame captures the field. Tile 2 of the output frame captures a part of a moving wheel of the tractor. The motion characteristics of Tile 1 are expected to be uniform or homogeneous, because the field moves to the right slowly and uniformly as the tractor travels to the left. The motion characteristics of Tile 2 are expected to be non-uniform and heterogeneous, because the wheel is moving in a rotational manner while the body of the tractor may remain in the same location in the frame. Tiles in the output frame are referred to herein as output tiles.

Part (b) of FIG. 2 illustrates X and Y motion vectors at each pixel of the output frame. Part (c) of FIG. 2 illustrates the X and Y motion vectors at each pixel of tile 2. Motion boundary 202 can be seen in both the X motion vectors and the Y motion vectors. A motion boundary can refer to the distinct spatial region within a tile where the motion vector information changes abruptly. For example, a motion boundary can mark the transition between areas exhibiting homogeneous motion and those with heterogeneous or non-uniform movement, such as the edge between a smoothly moving or stationary background and an object with complex or rotational motion.

Part (d) of FIG. 2 illustrates the reference regions for Tile 1 and Tile 2. Reference regions are also referred to herein as reference bounding boxes. The determination of the reference region (or reference tile) based on motion vectors of a given tile involves analyzing the motion characteristics within the tile of the output frame. Motion vectors, which encode the displacement of pixel locations from the output frame to the reference frame, are first calculated for each pixel or block in the output frame. For a tile exhibiting homogeneous motion (such as a slowly moving field), the reference region can be defined by applying a uniform motion vector across the entire tile, resulting in a reference region that maintains the same shape and size as the output tile. Because the motion vectors for Tile 1 are uniformly small, the reference region for Tile 1 is similar to the size of Tile 1. For tiles with heterogeneous or non-uniform motion (like a rotating tractor wheel), the reference region is determined by finding a reference region that encompasses all the pixel locations pointed to by the motion vectors from the output tile. The reference pixels referenced by the disparate motion vectors can be spread across a larger region and demand a larger reference region. The resulting reference region may differ in size or shape from the output tile, reflecting the complexity and variability of motion captured by the motion vectors. Because the motion vectors for Tile 2 are varied and heterogeneous, the reference region is significantly larger than the size of Tile 2.

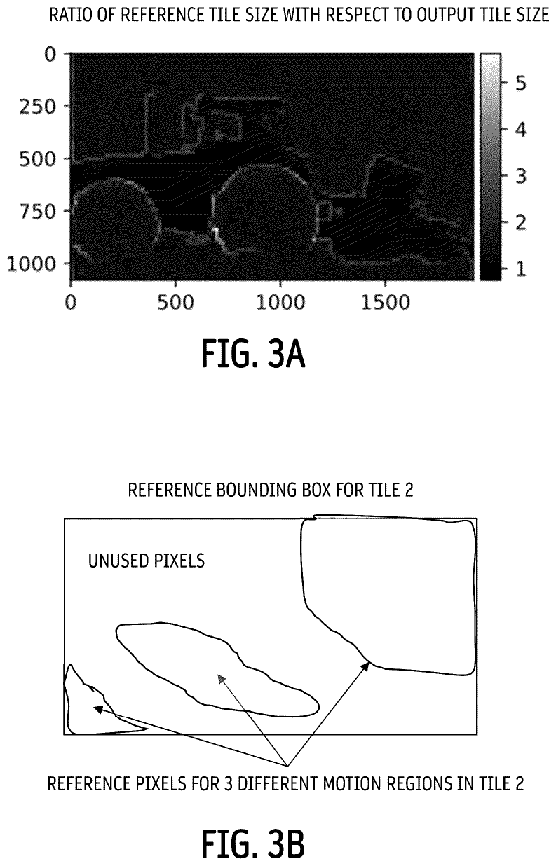

FIG. 3A illustrates a ratio of reference tile size with respect to output tile size, according to some embodiments of the disclosure. It can be seen that locations of motion boundaries in the output frame demand larger reference regions (or reference tiles), in terms higher ratios of the size of the reference region to the output tile size.

FIG. 3B illustrates a reference bounding box for a Tile 2 with heterogenous motion vector information, according to some embodiments of the disclosure. It can be seen that the reference bounding box for Tile 2 includes reference pixels for three different (uniform) motion regions in Tile 2, and the three patches of reference pixels are spread across the reference bounding box. Because of the motion boundary present in Tile 2, there are many unused pixels in the reference bounding box that are not needed for grid sampling processing and do not serve as a reference feature vector. Therefore, the motion boundary caused large wastages where significant portions of the reference data is not used or needed to perform feature vector interpolation in per-pixel grid sampling.

Unlike traditional block-based motion compensation, where reference regions correspond to contiguous, rectangular blocks readily transferred as a whole, grid sampling introduces significant irregularity in reference regions. This irregularity arises from the variation of MVs across individual pixels within a tile having heterogeneous characteristics. As each pixel may have a distinct motion vector, the reference pixels demanded for a single output tile are often scattered throughout the reference frame, rather than clustered together in a compact block. As a result, the reference region for the output tile becomes irregular and non-rectangular, as illustrated for Tile 2 in FIG. 3B. This scattered arrangement of reference pixels makes it difficult to efficiently transfer the reference data as a contiguous block or via block transfers. The lack of regularity in the reference pixel locations complicates data movement and can impact both latency and energy efficiency in video processing workflows.

In traditional block-based motion compensation, reference regions are defined as rectangular areas. The size of each reference region is determined directly by the width and height of the corresponding output block, allowing for simple and predictable calculation of reference region dimensions. In contrast, grid sampling introduces greater variability in the size of reference regions. In this approach, the size of the reference region for each tile is influenced by two key factors: the range of motion vectors present within the tile and the feature depth, which is a parameter set by the underlying neural network. As a result, the dimensions of the reference region cannot be determined in advance solely based on the tile size.

When tiles in an output frame have motion boundaries, multiple reference pixels or regions within the reference bounding box correspond to separate sets of pixels, each associated with distinct sets of motion vectors. These reference regions are often disjointed and scattered throughout the reference frame, rather than grouped together in a contiguous area. As a result, a large portion of the pixels inside the reference bounding box are not actually processed as reference pixels for the output tile, as seen in FIG. 3B. The unused pixels do not contribute to the grid sampling process or serve as reference feature vectors. Consequently, the block transfer of such a reference bounding box becomes highly inefficient, both in terms of latency and energy consumption, because the transfer process of the large reference bounding box involves moving a significant amount of unnecessary data, resulting in wasted resources and reduced processing efficiency.

Vectorizing computations presents significant challenges due to the explicit calculation of reference pixel indices and interpolation weights for each pixel. In traditional block-based motion compensation, reference pixel indices are easily determined using loop counter increments. However, grid sampling involves calculating each pixel's reference index by adding motion vectors to its position, with interpolation weights computed individually. Grid sampling processing includes accessing 16-bit or 32-bit floating-point values for the x and y components of the motion vector, which may reside in on-chip memory or, less optimally, in off-chip memory where memory access costs are high. Such irregular memory accesses and computational patterns hinder efficient execution of vectorized kernels on GPUs or NPUs, reducing performance and increasing latency.

### Sub-Tile-Based Execution of Grid Sampling

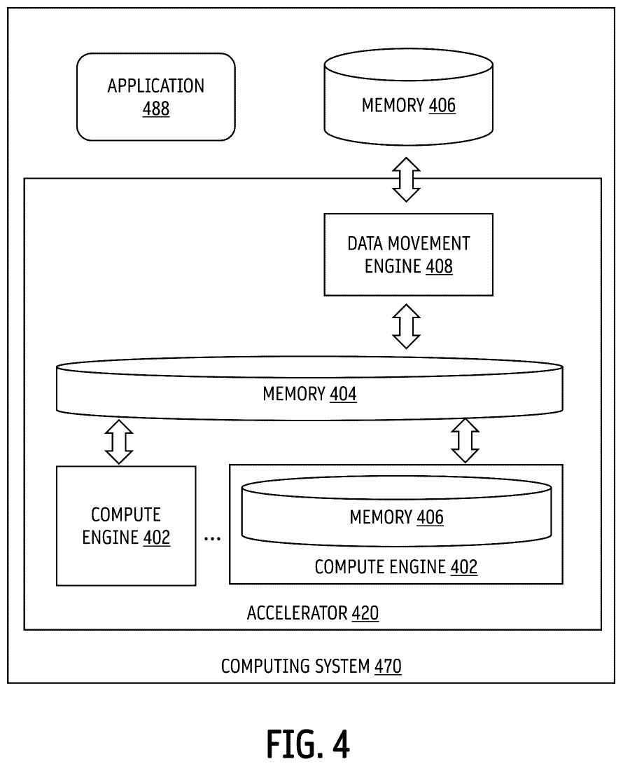

FIG. 4 illustrates computing system 470 for performing per-pixel operations, according to some embodiments of the disclosure. Computing system 470 may include one or more instances of accelerator 420 to accelerate neural network operations. In some implementations, computing system 470 may represent a SoC or an integrated circuit that integrates various components or circuits of a computer or electronic system, such as different types of processors different types of hardware accelerators, memory, input/output ports, and often onto a single chip or package.

Accelerator 420 may be a hardware accelerator designed to accelerate execution of neural network operations or other computing operations. Accelerator 420 can include one or more instances of compute engine 402.

Compute engine 402 may be optimized to perform specific neural network operations commonly found in neural networks, such as convolutions, matrix multiplications, applying activation functions, reshaping of tensors, etc. Examples of compute engine 402 can include a digital signal processor, a systolic array, multiply-and-accumulate array, analog compute-in-memory array, digital compute-in-memory array, an application-specific integrated circuit, a vector data processing circuit, a scalar data processing circuit, tensor processing circuit, reconfigurable fabric such as a field-programmable gate array, etc. Compute engine 402 may include one or more of instruction/configuration, input data, intermediate data, output data register files or buffers, collectively shown as memory 406, to store efficiently during execution of operations by compute engine 402.

Accelerator 420 may include memory 404 (sometimes referred to as on-chip memory), which may include Static Random Access Memory (SRAM). Memory 404 can represent high-speed storage for the one or more instances of compute engine 402. Memory 404 has proximity to the instances of compute engine 402 to facilitate low latency compute by the one or more instances of compute engine 402 and improves throughput for operations being performed by the one or more instances of compute engine 402 that demand frequent memory access.

Computing system 470 may include memory 406 (sometimes referred to as off-chip memory), which may include Dynamic Random Access Memory (DRAM). Memory 406 may have larger capacity than memory 404. Memory 406 can store bulk data and application-level information that cannot fit within the limited resources of memory 404.

Accelerator 420 may include data movement engine 408 which may facilitate and manage data transfers between different memory hierarchies, including on-chip and off-chip memory, e.g., memory 404 and memory 406. In some contexts, data movement engine 408 may be referred to as a direct memory access engine. Data movement engine 408 can perform direct memory access tasks (e.g., in parallel) to execute block data transfers, independently without intervention from instances of compute engine 402. Block data transfers allow large chunks of data to be moved between memories.

Application 488 represents the software layer running on computing system 470. Application 488 can trigger accelerator 420 to perform operations to support the functionalities of application 488. Application 488 may implement one or more functionalities and/or operations of an NVC-based encoder and/or an NVC-based decoder.

In view of the challenges of deploying grid sampling onto compute engine 402 discussed with FIGS. 1, 2, 3A, and 3B, a sub-tile-based grid sampling approach can be implemented to optimize loading reference data onto memory 404 efficiently and to increase compute throughput of compute engine 402 in performing per-pixel grid sampling. Optimizing the reference data involves structuring the data transfer at a sub-tile level to ensure that relevant portions or subsets of reference data are accessed and loaded onto memory 404. To further reduce latency, this approach effectively enables block-based execution directly from on-chip buffers (e.g., memory 406) and utilizes efficient block data transfers though data movement engine 408 for moving entire blocks of reference data. Additionally, feature data accesses from DRAM are minimized by decreasing reference bounding box wastage and potentially allowing reuse of shared reference pixels across neighboring pixels, which helps conserve bandwidth and improves memory utilization. By ensuring that memory 404 is populated with the reference data for each sub-tile along with optional metadata, compute engine 402 can quickly and easily access and process the reference data during per-pixel grid sampling operations. Organizing the reference data on a sub-tile basis leads to better overall system performance, reduced latency in neural network operations, and more efficient use of both on-chip and off-chip memory resources.

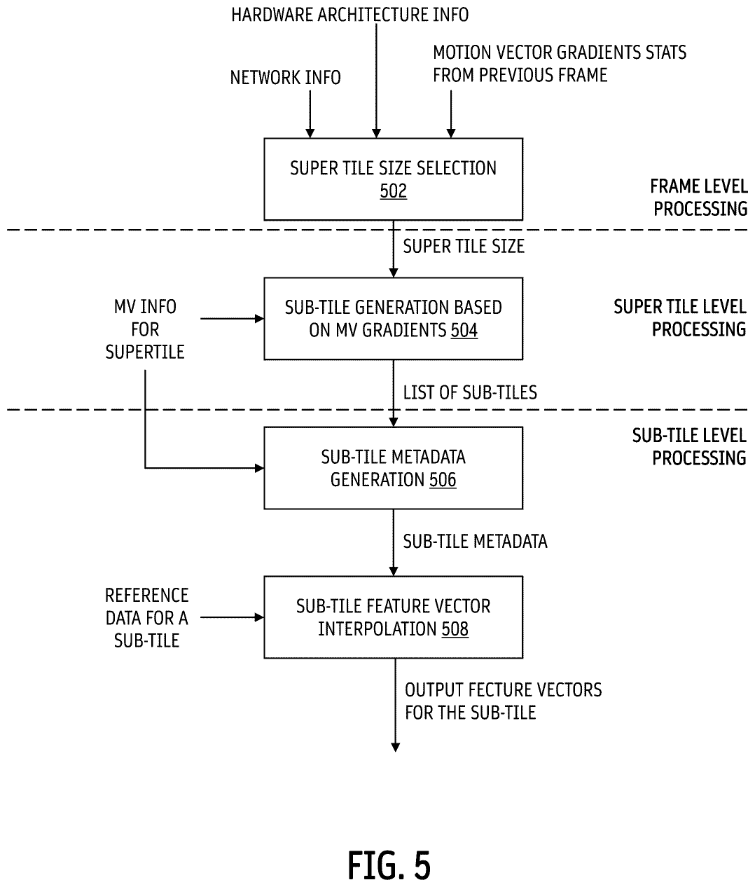

FIG. 5 illustrates a process flow for sub-tile-based grid sampling and data used in the process flow, according to some embodiments of the disclosure. Sub-tile-based grid sampling process involves frame level processing, super tile level processing, and sub-tile level processing. In particular, the process implements dynamic tiling based on homogeneity of motion vectors across pixels. The sub-tiles being used as a unit for block-based grid sampling are sized and set to create regular tiles of varying sizes such that the pixels with similar motion vectors are part of the same sub-tile. Higher homogeneity of motion vectors within a sub-tile leads to more compact and smaller reference bounding box for the tile, which not only reduces the data transfers but also allows for processing larger tiles in on-chip memory to achieve higher on-chip reuse of reference feature data.

At the frame level, a video frame is processed in 502 to determine or select a super tile size for the video frame. Determination of a super tile and/or a super tile size of the super tile can be performed once per frame. The super tile represents a rectangular region of the video frame. The video frame can be processed to identify or determine one or more super tiles. The video frame can be processed to determine a super tile size, and one or more super tiles can be determined based on the super tile size. The super tile size may be measured in terms of number of pixels along a width dimension and number of pixels along a height dimension. Determining or selecting a super tile size can be based on one or more of: neural network information, hardware architecture information, and motion vector information (e.g., motion vector gradient statistics from a previous frame). In one embodiment, the super tile size is determined based on whether the output tile and reference data can fit onto the on-chip memory (e.g., memory 404 of FIG. 4).

Neural network information can refer to one or more attributes specific to the neural network model in use, such number of channels in the feature vector and precision of the values in the feature vector. More channels and/or higher precision can contribute to larger demands on memory resources to store reference data, leading to a smaller super tile size being chosen or selected. Neural network information may include one or more of a dimension the reference data associated with the super tile (e.g., length of feature vectors) and a precision of the reference data associated with the super tile (e.g., number of bits of resolution).

Hardware architecture information can refer to constraints of compute and/or memory resources—such as the available size of on-chip memory (e.g., memory 404 of FIG. 4), the number of compute engines, or limitations in memory bandwidth. For example, if the on-chip memory (e.g., memory 404 of FIG. 4) has a certain availability or capacity, the super tile size can be adjusted to ensure that reference data for a super tile can be within the availability or capacity and potentially avoid memory overflows and costly off-chip memory accesses. Hardware architecture information can include memory availability of a memory accessible by the one or more compute engines (e.g., memory 404 of FIG. 4). Higher availability and capacity can lead to a larger super tile size being chosen or selected.

Motion vector information, such as motion vector gradient statistics obtained from a previous video frame, can refer to motion varies throughout the video frame. For example, high average motion vector gradients can lead to a smaller super tile size since the reference data size is correlated with motion vector gradients. Selecting the super tile size based on motion vector gradients can account for varying size of reference regions. Because motion vector gradients are highly correlated with each other between successive frames, the motion vector information for a current video frame, such as motion vector gradient statistics, can be based on motion vector information computed while processing a previous frame to reduce latency of inspecting motion vector information of the current video frame during super tile size selection in 502.

At the super tile level, given a super tile size determined or selected in 502, the video frame may be split into one or more super tiles. The super tiles of a video frame may have the same super tile size. The super tiles of a video frame may have different super tile sizes. A super tile may be processed in 504 to generate or create one or more sub-tiles based on motion vector information of the super tile, such as motion vector gradients. A list of sub-tiles for a super tile is passed on to sub-tile level processing.

In some embodiments, the super tile size is predetermined or preset, e.g., by a user or system configuration. In some embodiments, super tile size determination or selection in 502 may be skipped or omitted, where a frame may proceed to sub-tile generation in 504.

In some embodiments, the super tile size is selected in 502 based on the on-chip memory demanded for processing a super tile and the sub-tiles therein. The determination of the on-chip memory demanded for processing the super tile can be influenced by one or more factors or heuristics, e.g., the number of channels in the feature vector, the size of the output tile, and the dimensions of the corresponding reference bounding box. The total memory demanded for processing a super tile and its sub-tiles therein, denoted as Tile Memory, can include one or more of the following components: output tile size, reference coordinates tile size, interpolation positions tile size, and reference data tile size. In some examples, tile size is the total or sum of output tile size plus reference coordinates tile size, plus interpolation positions tile size, and plus reference data tile size (e.g., tile size=output tile size+reference coordinates tile size+interpolation positions tile size+reference data tile size).

For an output tile with dimensions H (height) and W (width), where C is the number of channels in the feature vector and P is the precision (number of bytes per element in the feature vector), the memory usage for each tensor (e.g., each feature vector) involved in grid sampling can be calculated as follows: output tile size: H×W×C×P bytes. The reference coordinates title size can be calculated as follows: reference coordinates tile size: H×W×2×2 bytes (two indices per pixel, one each for the x and y directions, with 2 bytes allocated for each index). The interpolation positions tile size can be calculated as follows: interpolation positions tile size: H×W×2×2 bytes (two interpolation positions per pixel, one each for the x and y directions, with 2 bytes per position). The reference data tile size can be calculated as follows: reference data tile size: reference bounding box size×C×P bytes. The reference bounding box size can vary between tiles due to differences in the motion vectors present within each tile, or based on the distribution of motion vectors in the tile. The most probable size of the reference bounding box can be determined based on the average gradient of the motion vectors. The tile-to-tile variation in motion vector distributions can be modeled using the average gradient of x motion vectors and y motion vectors. The calculation is as follows: reference bounding box size=(H×(1+|mv_y_grad|)+padding)×(W×(1+|mv_x_grad|)+padding). mv_x_grad and mv_y_grad are the average gradients of x and y motion vectors at different pixels within the tile respectively. The reference bounding box size calculation can be performed for a super tile and/or a sub-tile within a super tile. Because motion vector information does not typically change abruptly between consecutive or successive frames, the motion vector statistics from the previous frame can be utilized to estimate the most likely reference bounding box size for the current frame. For the initial frame in a sequence of video frames of a video, the reference bounding box can be set equal to the output tile size, optionally with additional padding applied.

At the sub-tile level, metadata is determined or generated (e.g., precalculated) for one or more sub-tiles of a super tile in 506. The metadata is passed on to facilitate operations performed in sub-tile-based processing, such as sub-tile-based grid sampling or feature vector interpolation. The metadata encapsulates useful information about how each sub-tile is to be processed. The metadata can be used to dramatically reduce redundant and irregular memory accesses and speed up computation. Metadata can be stored in a compact data structure.

Metadata can include reference bounding box coordinates and/or dimensions for the reference region of a particular sub-tile. For a sub-tile being processed, the reference bounding box coordinates and/or dimensions can be used in programming block data transfers between off-chip memory and on-chip memory to move the reference data for processing the sub-tile. The reference bounding box information can be determined based on motion vector information associated with a given sub-tile.

Metadata can include a local/relative index, pointer, location, or memory index for reference data associated with a reference pixel for an output pixel of the sub-tile. The memory index can be used by a compute engine to load reference data associated with the reference pixel from the on-chip memory for further processing.

Metadata can include one or more interpolation weights corresponding to one or more reference pixels in the reference bounding box for the output pixel of the sub-tile. The one or more interpolation weights can be used by a compute engine for processing the reference data, e.g., to perform feature vector interpolation of four feature vectors, where each feature vector has a corresponding interpolation weight.

At the sub-tile level, the sub-tile metadata determined in 506 is utilized by a compute engine (e.g., compute engine 402 of FIG. 4) to perform sub-tile feature vector interpolation in 508. The compute engine can receive reference data corresponding to the reference bounding box for a sub-tile, as specified in the sub-tile metadata. The compute engine can load reference data for per-pixel grid sampling using the sub-tile metadata. The compute engine can apply interpolation weights for per-pixel grid sampling using the sub-tile metadata. The compute engine can output feature vectors for the sub-tile.

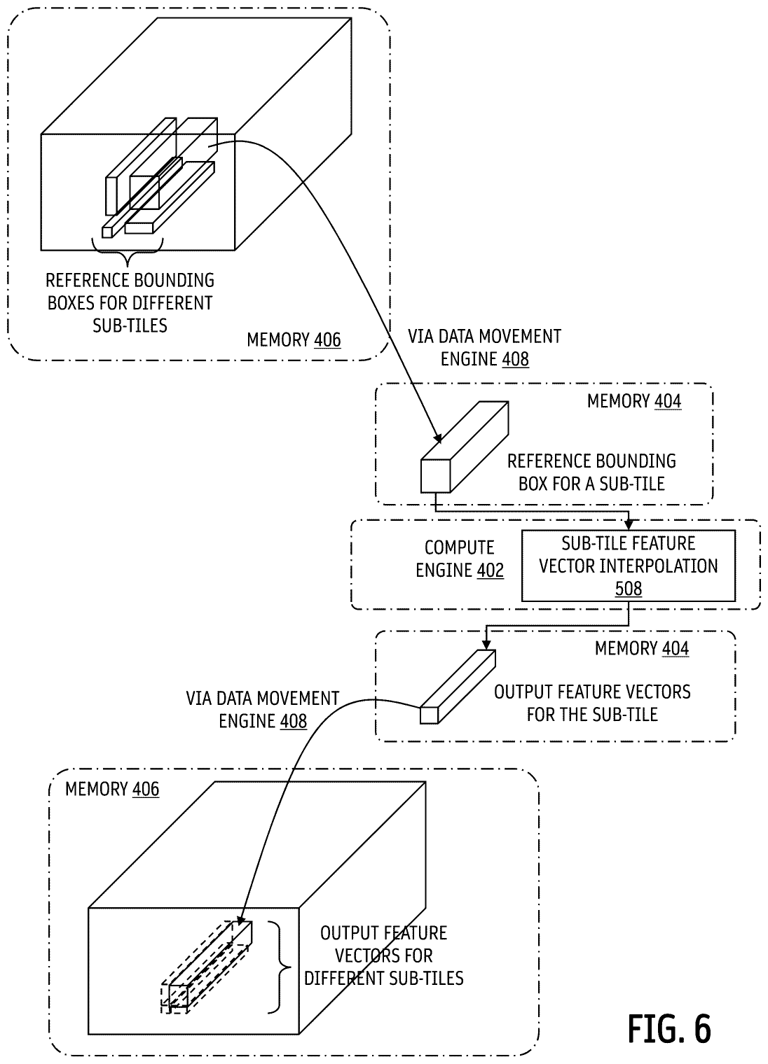

FIG. 6 illustrates efficient data movement supporting sub-tile-based grid sampling, according to some embodiments of the disclosure. Data movement engine 408 can perform block data transfer (e.g., using direct memory access tasks) of reference data bounded by a reference bounding box for a sub-tile (e.g., subset of reference data according to the reference bounding box) and move the reference data from memory 406 to memory 404 accessible by a compute engine. Using the subset of reference data on memory 404, the compute engine can perform sub-tile feature vector interpolation. The compute engine can store one or more output feature vectors for the sub-tile in memory 404. Data movement engine 408 can perform block data transfer (e.g., using direct memory access tasks) of the output feature vectors for the sub-tile and move the output feature vectors for the sub-tile from memory 404 to memory 406.

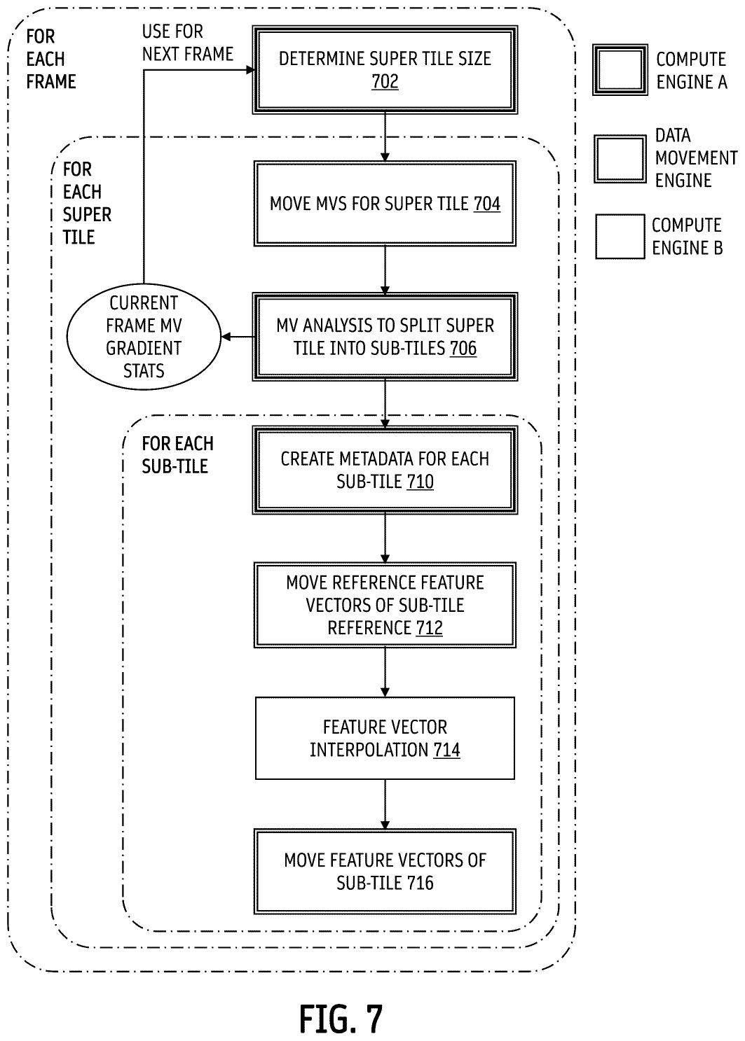

FIG. 7 illustrates a process flow for sub-tile-based grid sampling including data movement stages, according to some embodiments of the disclosure.

In 702 (similar to 502 of FIG. 5), a super tile size that is likely to fit into the on-chip memory can be selected for a video frame. The video frame can be divided into one or more super tiles according to the super tile size. A compute engine, depicted as compute engine A, can be used to execute operations for 702, such as a digital signal processor (DSP), an application-specific integrated circuit (ASIC), a vector data processor, a GPU, a field-programmable gate array (FPGA), etc.

In 704, motion vectors, e.g., the X and Y components of motion vectors (mv-X, mv-Y) associated with a super tile, are moved from off-chip memory (e.g., memory 406 of FIG. 6) onto on-chip memory (e.g., memory 404 of FIG. 4) by a data movement engine (e.g., data movement engine 408 of FIG. 4) via one or more 2D block direct memory access transfer tasks. In some embodiments, the data movement engine moves a subset of the motion vector information corresponding to the super tile to on-chip memory for the one or more compute engines. The subset of the motion vector information can be used by the one or more compute engines to perform motion vector analysis.

In 706 (similar to 504 of FIG. 5), motion vector analysis is performed to split a super tile into sub-tiles. Compute engine A can be used to execute operations for 706, utilizing the motion vectors associated with the super tile on the on-chip memory. Optionally, the calculated motion vector information from the motion vector analysis can be used for the next frame in 702.

In 710 (similar to 506 of FIG. 5), metadata for a sub-tile can be created. Compute engine A can be used to execute operations for 710, optionally utilizing the motion vectors associated with the super tile on the on-chip memory. The metadata facilitates independent processing of sub-tiles.

In 712, reference data, e.g., reference feature vectors for a sub-tile of super tile, are moved from off-chip memory (e.g., memory 406 of FIG. 4) onto on-chip memory (e.g., memory 404 of FIG. 4) by a data movement engine (e.g., data movement engine 408 of FIG. 4) via one or more 2D block direct memory access transfer tasks. The data movement engine can use the reference bounding box information in the metadata to fetch the relevant reference data.

In 714 (similar to 508 of FIG. 5), per-pixel grid sampling, e.g., feature vector interpolation is performed to generate one or more output feature vectors. A compute engine, depicted as compute engine B, can be used to execute data parallel operations for 702, such as a compute array, a multiply-and-accumulate array, a DSP, an ASIC, a GPU, an FPGA, etc. The compute engine B can utilize the metadata, such as the per-pixel metadata, to load reference feature vectors at a corresponding set of four reference pixels and optionally interpolation weights corresponding to the four reference pixels. The compute engine B can write the one or more output feature vectors onto an on-chip memory. In some embodiments, per-pixel grid sampling can be executed by a data parallel compute array, where the compute array can perform one or more operations or calculations for a plurality of pixels of a sub-tile in parallel.

In 716, the one or more output feature vectors, e.g., reference feature vectors for a sub-tile of super tile, are moved from on-chip memory (e.g., memory 404 of FIG. 4) by a data movement engine (e.g., data movement engine 408 of FIG. 4) via one or more 2D block direct memory access transfer tasks to off-chip memory (e.g., memory 406 of FIG. 4). The data movement engine can use the reference bounding box information in the metadata to fetch the relevant reference data.

In some embodiments, a computing system or an integrated circuit, e.g., illustrated in FIG. 4, can include a memory, a processor coupled to the memory, a data movement engine, and a compute array coupled to the memory. The processor and the compute array represent examples of compute engines of the computing system or integrated circuit. The memory can represent fast memory that is accessible by the compute engines. The data movement engine can load data onto the memory to make the data accessible to the compute engines. The underlying architecture of the processor may make the processor more suitable for vector data processing, e.g., vectorized operations including calculation of row sums and gradients. In some examples, the processor may be a single instruction, multiple data (SIMD) processor. The underlying architecture of the compute array may make the compute array more suitable for high-throughput, data parallel computations, e.g., element-wise calling and addition operations in feature vector interpolation.

In the context of the processing flow illustrated in FIG. 7, the processor may be used for performing 702, 706, and 710, and the compute array may be used for performing 714. For example, the processor may determine a super tile of a video frame of a video, split the super tile into one or more sub-tiles, and determine a reference bounding box for a sub-tile and per-pixel metadata for the sub-tile.

In some embodiments, the processor may perform control functions to control the data movement engine to perform 704, 712, and 716 at suitable points in time of the process flow and trigger the processor and the compute array to perform certain operations at suitable points in time in the process flow.

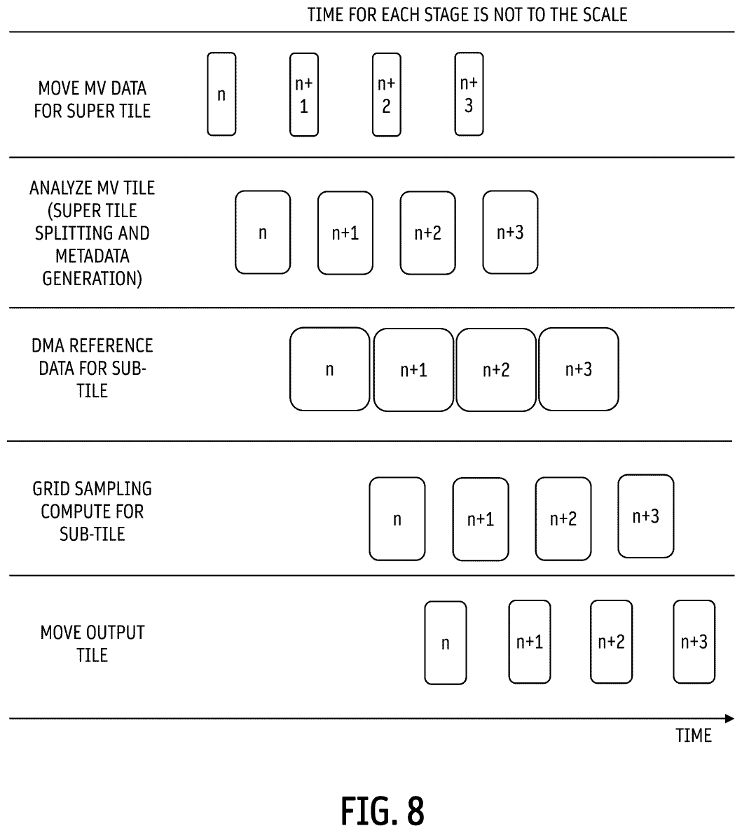

FIG. 8 illustrates pipelining stages of sub-tile-based grid sampling, according to some embodiments of the disclosure. In particular, the processing flow for sub-tile-based grid sampling, as illustrated in FIG. 7 can be organized to have five stages of execution: a stage corresponding to 704, a stage corresponding to 706 and 710, a stage corresponding to 712, a stage corresponding to 714, and a stage corresponding to 716. Depending upon bandwidth and compute resources, actual latencies of each stage can vary. In some embodiments, one or more stages (for example the state corresponding to 704 and the stage corresponding to 706 and 710) can be combined to reduce the pipelined stages. Pipelining is especially useful in the context of sub-tile-based grid sampling for neural video codecs because it allows different stages of the processing flow to operate simultaneously, rather than sequentially. By overlapping stages in time, pipelining ensures that each hardware unit (e.g., the one or more compute engines and the data movement engine) is busy, minimizing idle time and speeding up overall processing. Different stages of the pipeline can be mapped to different hardware resources (e.g., the one or more compute engines and the data movement engine), allowing parallel execution and better use of available compute and memory bandwidth. Pipelining helps achieve the throughput demanded for real-time deployment by ensuring that new data can enter the pipeline, in some cases, before previous data has fully exited. More importantly, sub-tile-based grid sampling can add additional processing because sub-tiles and metadata for the sub-tiles are generated to facilitate processing. Pipelining can hide the latency of the processing stages to allow subsequent stages to begin processing as soon as the next sub-tile is ready to be processed, rather than waiting for the whole process flow to finish before beginning on the next sub-tile.

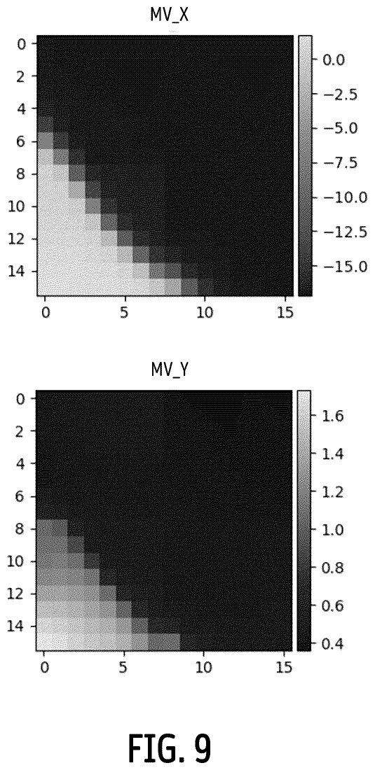

FIGS. 9-11 illustrate splitting a super tile into one or more sub-tiles, according to some embodiments of the disclosure. Splitting a super tile into one or more sub-tiles is to minimize the size of reference region for a sub-tile. To split a super tile, the motion vector information, in particular, the motion vector gradient in the horizontal direction and the further motion vector gradient in the vertical direction of the super tile are used to create sub-tiles. More specifically, one or more motion boundaries in the super tile are determined based on the motion vector information, and the super tile is split into one or more sub-tiles at the one or more motion boundaries. The sub-tiles can represent one or more further rectangular regions of the super tile. Examining the motion vector gradients in the vertical and horizontal directions can ensure that the pixels with similar motion vectors would be grouped or clustered in same a sub-tile which in turn minimizes the area of reference bounding box for the sub-tile.

FIG. 9 illustrates the motion vectors in the x-dimension and motion vectors in the y-dimension for a super tile.

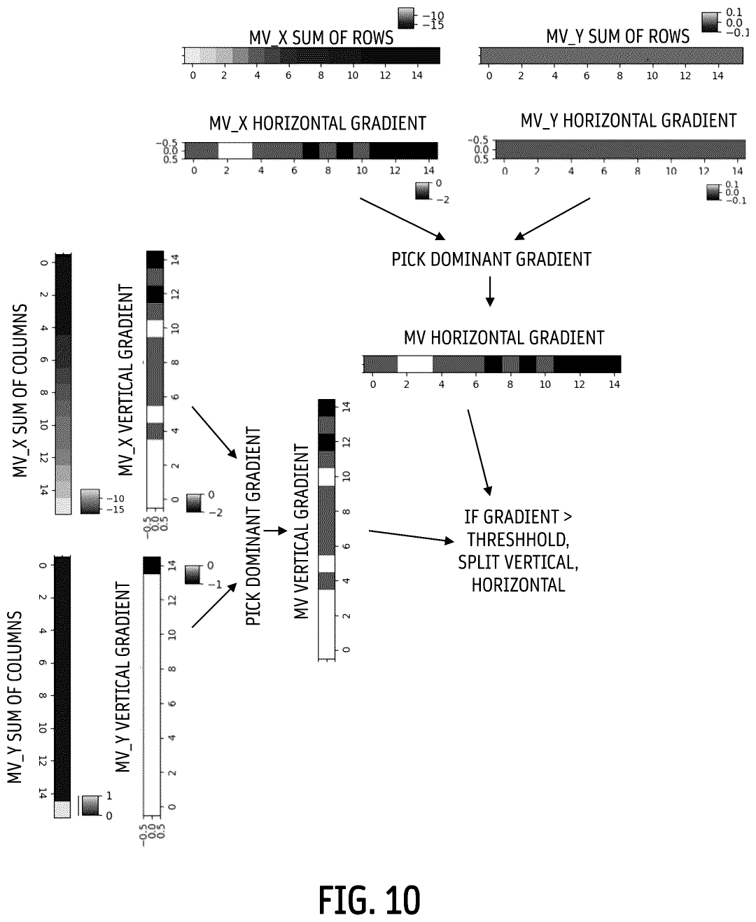

FIG. 10 illustrates the process of determining the motion vector gradient in the horizontal direction (MV HORIZONTAL GRADIENT) and the further motion vector gradient in the vertical direction (MV VERTICAL GRADIENT). MV HORIZONTAL GRADIENT is referred to herein as a gradient of motion vectors along a horizontal direction. MV VERTICAL GRADIENT is referred to herein as a gradient of motion vectors along a vertical direction.

The rows and columns of the motion vectors in the x-dimension are accumulated to determine MV_X SUM OF ROWS and MV_X SUM OF COLUMNS. MV_X SUM OF ROWS represents a row-wise sum-vector of the X-component of the motion vectors and is calculated by summing the X-component of the motion vectors across each row of the super tile. MV_X SUM OF COLUMNS represents a column-wise sum-vector of the X-component of the motion vectors and is calculated by summing the X-component of the motion vectors down each column of the super tile.

The rows and columns of the motion vectors in the y-dimension are accumulated to determine MV_Y SUM OF ROWS and MV_Y SUM OF COLUMNS. MV_Y SUM OF ROWS represents a row-wise sum-vector of the Y-component of the motion vectors and is calculated by summing the Y-component of the motion vectors across each row of the super tile. MV_Y SUM OF COLUMNS represents a column-wise sum-vector of the Y-component of the motion vectors and is calculated by summing the Y-component of the motion vectors down each column of the super tile.

For MV_X SUM OF COLUMNS, a MV_X VERTICAL GRADIENT is calculated by subtracting a shifted version of MV_X SUM OF COLUMNS from MV_X SUM OF COLUMNS. MV_X VERTICAL GRADIENT represents the element-wise difference between adjacent entries in MV_X SUM OF COLUMNS and quantifies or captures one or more changes in motion across the vertical axis or direction.

For MV_Y SUM OF COLUMNS, a MV_Y VERTICAL GRADIENT is calculated by subtracting a shifted version of MV_Y SUM OF COLUMNS from MV_Y SUM OF COLUMNS. MV_Y VERTICAL GRADIENT represents the element-wise difference between adjacent entries in MV_Y SUM OF COLUMNS and quantifies or captures one or more changes in motion across the vertical axis or direction.

For MV_X SUM OF ROWS, a MV_X HORIZONTAL GRADIENT is calculated by subtracting a shifted version of MV_X SUM OF ROWS from MV_X SUM OF ROWS. MV_X HORIZONTAL GRADIENT represents the element-wise difference between adjacent entries in MV_X SUM OF ROWS and quantifies or captures one or more changes in motion across the horizontal axis or direction.

For MV_Y SUM OF ROWS, a MV_Y HORIZONAL GRADIENT is calculated by subtracting a shifted version of MV_Y SUM OF ROWS from MV_Y SUM OF ROWS. MV_Y HORIZONTAL GRADIENT represents the element-wise difference between adjacent entries in MV_Y SUM OF ROWS and quantifies or captures one or more changes in motion across the horizontal axis or direction.

One dominant vertical gradient is selected from MV_X VERTICAL GRADIENT and MV_Y VERTICAL GRADIENT. One dominant horizontal gradient is selected from MV_X HORIZONTAL GRADIENT and MV_Y HORIZONTAL GRADIENT. In the illustrative example, MV_X VERTICAL GRADIENT is selected as the MV VERTICAL GRADIENT. In the illustrative example, MV_X HORIZONTAL GRADIENT is selected as the MV HORIZONTAL GRADIENT.

A dominant gradient can be selected based on a sum of magnitudes (e.g., absolute values) in the gradient. A dominant gradient can be selected based on a maximum value of the magnitudes in the gradient. A dominant gradient can be selected based on a mean of the magnitudes in the gradient.

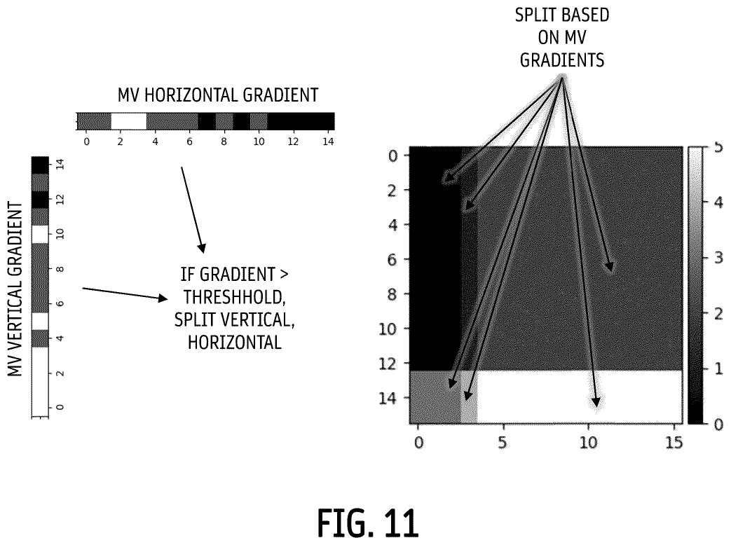

The indices in MV VERTICAL GRADIENT and MV HORIZONTAL GRADIENT where gradients exceed a threshold indicate motion boundaries (e.g., where the motion changes drastically). These indices are used to define the sub-tiles within the super tile or split the super tile into sub-tiles. The threshold can be configurable or programmable, depending on how aggressively the algorithm is to cluster similar motion vectors. Example resulting sub-tiles split at indices whose value exceed a threshold are illustrated in FIG. 11.

The sub-tile splitting algorithm illustrated in FIGS. 9-11 represents a non-hierarchical algorithm for dynamic tile splitting using horizontal and vertical gradients of motion vectors to avoid large wasteful transfers of reference data. A non-hierarchical algorithm to split a super tile without exhaustive and recursive searching algorithms can be efficient while being sufficiently accurate at partitioning a super tile into sub-tiles having homogeneous motion vector information. The operations in the algorithm are also readily and efficiently vectorizable since they operate on rows and columns of motion vector data, making the algorithm highly suitable for vectorized execution on certain types of compute engines optimized for vector processing, e.g., using element-wise vector add/subtract. Examples of vectorizable operations in the algorithm includes row and column sum operations, gradient calculations, reference index generation, and interpolation weight calculation.

Example pseudocode for a super tile splitting algorithm is as follows:

Inputs:
H, W: integers representing input super tile dimensions (height
× width)
mv_x: HxW array of motion vectors in x direction.
mv_y: HxW array of motion vectors in x direction.
grad_thresh: MV vector gradient threshold for edge detection
Outputs:
tile_list: list of tuples (tile_start_x, tile_start_y,
tile_width, tile_height)
mv_x_grad : Avg Gradient of x comp of MV
mv_y_grad : Avg Gradient of y comp of MV
Begin:
Initialize coord_x_row = array[0,1,2, ...,W-1]
Initialize row_sum_mv_x = array[0,0,...,0]
Initialize row_sum_mv_y = array[0,0,...,0]
Initialize col_sum_mv_x = array[0,0,...,0]
Initialize col_sum_mv_y = array[0,0,...,0]
Initialize mv_x_grad_along_cols = array[0,0,...,1]
Initialize mv_x_grad_along_rows = array[0,0,...,1]
Initialize mv_y_grad_along_cols = array[0,0,...,1]
Initialize mv_y_grad_along_rows = array[0,0,...,1]
For row in from 0 to H-1 :

Read a row of mv_x and mv_y into row_mv_x, and row_mv_y
row_sum_mv_x += row_mv_x
col_sum_mv_x[row] = sum(row_mv_x)
row_sum_mv_y += row_mv_y
col_sum_mv_y[row] = sum(row_mv_y)

mv_x_grad_along_cols = row_sum_mv_x[0:W-2] − row_sum_mv_x[1:W-
1]
mv_y_grad_along_cols = row_sum_mv_y[0:W-2] − row_sum_mv_y[1:W-
1]
mv_x_grad_along_rows = col_sum_mv_x[0:H-2] − col_sum_mv_x[1:H-
1]
mv_y_grad_along_rows = col_sum_mv_y[0:H-2] − col_sum_mv_y[1:H-
1]
edge_along_cols = 1 if (mv_x_grad_along_cols > grad_thresh |
mv_y_grad_along_cols > grad_thresh) else 0
edge_along_rows = 1 if (mv_x_grad_along_rows > grad_thresh |
mv_y_grad_along_rows > grad_thresh) else 0
mv_x_grad_along_cols_abs_sum = sum(abs(mv_x_grad_along_cols)
mv_y_grad_along_cols_abs_sum = sum(abs(mv_y_grad_along_cols)
mv_x_grad_along_rows_abs_sum = sum(abs(mv_x_grad_along_rows)
mv_y_grad_along_rows_abs_sum = sum(abs(mv_y_grad_along_rows)
mv_x_grad_avg = MAX(mv_x_grad_along_cols_abs_sum / W,
mv_x_grad_along_rows_abs_sum / H )
mv_y_grad_avg = MAX(mv_y_grad_along_cols_abs_sum / W,
mv_y_grad_along_rows_abs_sum / H )
Create tile list using edges_along_cols and edges_along_rows.
(e.g., 2 for-loops in software)

Description of the Pseudocode

Inputs
H, W: The height and width of the super tile (a rectangular
region in the video frame).
mv_x: A 2D array (size H×W) having the motion vectors in the x
direction for each pixel.
mv_y: A 2D array (size H×W) having the motion vectors in the y
direction for each pixel.
grad_thresh: A threshold value used to detect significant
changes (edges) in motion vectors.
Outputs
tile_list: A list of sub-tiles, each described by its starting
coordinates and size (x, y, width, height).
mv_x_grad: The average gradient of the x component of the
motion vectors.
mv_y_grad: The average gradient of the y component of the
motion vectors.

Algorithm Operations

0. Initialize Arrays
Create an array representing the x-coordinates for each column
in the super tile.
Initialize arrays to accumulate the sum of motion vectors for
each row and column, for both x and y directions.
1. Process Each Row
For every row in the super tile:

| | |
|---|---|
| ∘ | Read the corresponding row of x and y motion vectors. |
| ∘ | Add the values of the current row to the running total for |
| | row sums (for both x and y). |
| ∘ | Calculate the sum of the current row and store it in the |
| | column sum arrays (for both x and y). |

2. Calculate Gradients
Compute the difference between adjacent entries in the row sums
to get the gradient along columns (for both x and y).
Compute the difference between adjacent entries in the column
sums to get the gradient along rows (for both x and y).
3. Detect Edges (Motion Boundaries)
For each column, check if either the x or y gradient exceeds
the threshold. If so, mark it as an edge along columns.
For each row, check if either the x or y gradient exceeds the
threshold. If so, mark it as an edge along rows.
4. Compute Gradient Sums and Averages
Calculate the sum of the absolute values of the gradients for
each direction (x and y, along both rows and columns).
Compute the average gradient for x and y by dividing the sum by
the number of columns (for column gradients) or rows (for row
gradients), and take the maximum value for each direction.
5. Create Sub-Tile List
Use the detected edges along columns and rows to define the
boundaries of sub-tiles.
Iterate through the edges (typically using nested loops) to
generate a list of sub-tiles, each described by its starting
position and size.

Summary

This algorithm analyzes the motion vectors within a super tile
to find regions where the motion changes significantly (motion
boundaries). By calculating gradients and comparing them to a
threshold, it identifies where to split the super tile into
smaller, more homogeneous sub-tiles. The result is a list of
sub-tiles and statistics about the motion vector gradients,
which can be used for efficient grid sampling in neural video
codecs.

In some embodiments, a dominant vertical gradient is selected from MV_X VERTICAL GRADIENT and MV_Y VERTICAL GRADIENT, and a dominant horizontal gradient is selected from MV_X HORIZONTAL GRADIENT and MV_Y HORIZONTAL GRADIENT. Then, the selected dominant vertical gradient and the selected dominant horizontal gradient are used for determining motion boundaries in horizontal and vertical directions respectively. Determining motion boundaries can include selecting a dominant horizontal gradient from horizontal gradients of x-component and y-component of the motion vector, and selecting a dominant vertical gradient from vertical gradients of x-component and y-component of the motion vector, and comparing the dominant horizontal and vertical gradients against the threshold.

In some embodiments, both MV_X VERTICAL GRADIENT and MV_Y VERTICAL GRADIENT are compared against the threshold, where either one of or both an index of MV_X VERTICAL GRADIENT or the index MV_Y VERTICAL GRADIENT crossing the threshold constitutes as a motion boundary in the vertical direction. In addition, both MV_X HORIZONTAL GRADIENT and MV_Y HORIZONTAL GRADIENT are compared against the threshold, where either one of or both an index of MV_X HORIZONTAL GRADIENT or the index MV_Y HORIZONTAL GRADIENT crossing the threshold constitutes as a motion boundary in the horizontal direction. Determining motion boundaries can include comparing the horizontal gradients of the x-component and y-component individually against respective thresholds and marking indices where any of the horizontal gradients cross the threshold as motion boundaries in the horizontal direction, and comparing the vertical gradients of the x-component and y-component individually against the threshold and marking indices where any (either one) of the vertical gradients cross the threshold as motion boundaries in the vertical direction. The marking of motion boundaries in this fashion is reflected in the pseudocode above as:

edge_along_cols = 1 if (mv_x_grad_along_cols > grad_thresh |
mv_y_grad_along_cols > grad_thresh) else 0
edge_along_rows = 1 if (mv_x_grad_along_rows > grad_thresh |
mv_y_grad_along_rows > grad_thresh) else 0

Explanation of Pseudocode

| ∘ | edge_along_cols: | |
|---|---|---|
| | For each column, check if either the gradient of the | |
| | motion vectors in the x direction (mv_x_grad_along_cols) | |
| | or the gradient in the y direction (mv_y_grad_along_cols) | |
| | is greater than the threshold (grad_thresh). | |
| | ◯ | If either gradient is above the threshold, mark this |
| | | column as an “edge” by setting edge_along_cols to 1. |
| | ◯ | If neither gradient is above the threshold, set |
| | | edge_along_cols to 0. |
| ∘ | edge_along_rows: | |
| | For each row, check if either the gradient of the motion | |
| | vectors in the x direction (mv_x_grad_along_rows) or the | |
| | gradient in the y direction (mv_y_grad_along_rows) is | |
| | greater than the threshold (grad_thresh). | |
| | ◯ | If either gradient is above the threshold, mark this |
| | | row as an “edge” by setting edge_along_rows to 1. |
| | ◯ | If neither gradient is above the threshold, set |
| | | edge_along_rows to 0. |

Summary

| | |
|---|---|
| ∘ | These lines are used to detect boundaries (edges) in the |
| | motion vector field, either along columns or rows. |
| ∘ | An edge is detected if either the x or y gradient at that |
| | position is strong enough (exceeds the threshold). |
| ∘ | The result is a binary indicator (1 for edge, 0 for no |
| | edge) for each column and row, which is later used to |
| | split the super tile into sub-tiles where motion changes |
| | significantly. |

In some embodiments, a super tile is split using one or more motion boundaries determined in the horizontal direction and the vertical direction. In some embodiments, a super tile is split using (only) one or more motion boundaries determined in the horizontal direction. In some embodiments, a super tile is split using (only) one or more motion boundaries determined in the vertical direction.

In some embodiments, the threshold used for determining motion boundaries can be adjustable, adaptable, or configurable. For example, the threshold can be adjusted at a frame level. In some implementations, the threshold can be adjusted for each frame based on one or more metrics indicating efficiency of reference data transfers, such as ratio of total reference pixels to the number of pixels in the frame from one or more previous frame.

In some embodiments, different thresholds can be used for comparison against motion vector gradients in horizontal and vertical directions. Different thresholds can be set based on one or more characteristics of the frame or other heuristics, such as efficiency of reference data transfers in the horizontal and vertical directions.

In some embodiments, for each super tile, the maximum of mv_x_grad_along_rows (MV_X HORIZONTAL GRADIENT) and mv_x_grad_along_cols (MV_X VERTICAL GRADIENT) is stored as mv_x_grad, and the maximum of mv_y_grad_along_rows (MV_Y HORIZONTAL GRADIENT) and mv_y_grad_along_cols (MV_Y VERTICAL GRADIENT) is stored as mv_y_grad. mv_x_grad and mv_y_grad stored for a super tile of a frame can be used in calculating the average of mv_x_grad of the super tile and the average of mv_y_grad of the super tile. The average of mv_x_grad of the super tile of the frame and the average of mv_y_grad of the super tile of the frame can be used in estimating the reference bounding box dimensions and in calculating the super tile size for the further frame.

Implementing the algorithm to split the super tile based on a motion vector gradient in the horizontal direction and/or a motion vector gradient in the vertical direction can have one or more technical advantages. Having two gradients (or two gradient vectors) corresponding to the horizontal direction and the vertical direction of the super tile enables the algorithm to split the super tile by making horizontal cuts or dividers and vertical cuts or dividers in a non-hierarchical manner and split the super tile into rectangular sub-tiles. In addition, summing motion vectors along rows and down columns before gradient calculation can make the process of motion boundary determination more immune or resilient to noise in motion vectors, which are inherently noisy.

As discussed with FIGS. 5 and 7, metadata can be determined and calculated for a sub-tile and optionally for pixels of the sub-tile. For a particular sub-title, the metadata can include one or more reference coordinates and one or more dimensions to specify the reference bounding box for the reference data corresponding to the sub-tile. The reference bounding box can be calculated based on the motion vector information of the sub-tile. In some embodiments, per-pixel metadata can be calculated, including one or more reference pixel indices and optionally the interpolation weights corresponding to reference pixels for a given pixel. The reference bounding box information and the per-pixel metadata can be stored as compact metadata. The metadata can facilitate sub-tile-based grid sampling execution at the sub-tile level, so that information being used to perform per-pixel operations for grid sampling is readily available to data movement engine to move the relevant reference data for the sub-tile and to the compute engine to load data being used for the operations.

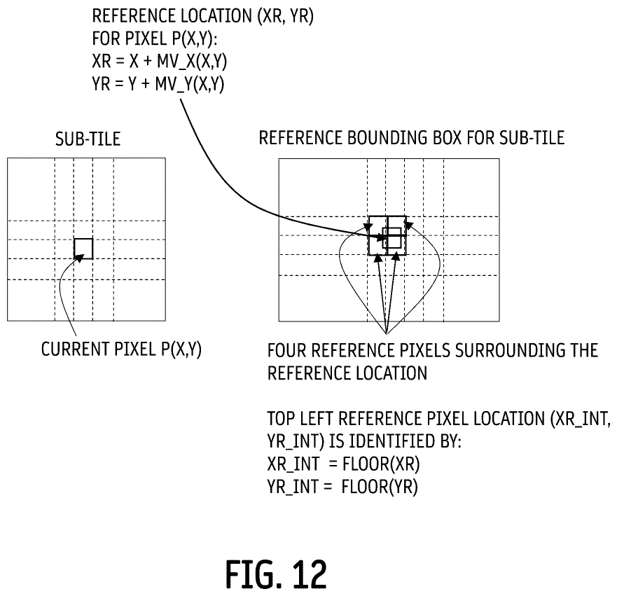

FIG. 12 illustrates calculating a memory index corresponding to reference data associated with a reference pixel in a reference bounding box, according to some embodiments of the disclosure. The left box represents a sub-tile. A current pixel is represented by P(X,Y). The right box represents a reference bounding box for the sub-tile. The coordinates and/or dimensions of the reference bounding box can be found in the metadata determined for the sub-tile. Each pixel in the sub-tile has a reference location specified by the motion vector for the pixel, represented by [MV_X (X,Y), MV_Y (X,Y)]. The reference location for the current pixel P(X,Y) can be represented by (XR, YR), where XR=X+MV_X(X,Y) and YR=Y+MV_Y(X,Y). The reference location can be a fractional pixel location, and can have four reference pixels surrounding the reference location. Reference data, e.g., feature vectors, corresponding to the four reference pixels surrounding the reference location are used in per-pixel grid sampling or feature vector interpolation.

In some embodiments, the metadata includes one or more memory indices that points to the relevant reference data corresponding to the one or more reference pixels within the reference data corresponding to the sub-tile. In some embodiments, instead of storing two or more memory indices corresponding to two or more reference pixels, the metadata includes only one memory index that points to relevant reference data corresponding to a single reference pixel, such as the top-left pixel only, the top-right pixel only, the bottom-left pixel only, or the bottom-right pixel only. Because the four reference pixels are in a fixed grid pattern, the memory indices pointing to the relevant reference data corresponding to the other reference pixels can be derived from the one memory index from the fixed grid pattern (e.g., implicitly by adding and/or subtracting an appropriate offset). For instance, the top-left reference pixel can be identified by (XR_INT, YR_INT) where XR_INT=FLOOR(XR) and YR_INT=FLOOR(YR).

Example metadata for a sub-tile can include the following:

| | |
|---|---|
| ct_x_start | top-left x-coordinate of the sub-tile in off- |
| | chip memory |
| ct_y_start | top-left y-coordinate of sub-tile in off-chip memory |
| ct_width | width of sub-tile |
| ct_height | height of sub-tile |
| ref_bb_x_start | Top-left x-coordinate of reference bounding box in |
| | off-chip memory |
| ref_bb_y_start | Top-left y-coordinate of reference bounding box in |
| | off-chip memory |
| ref_bb_width | Reference bounding box width |
| ref_bb_height | Reference bounding box height |

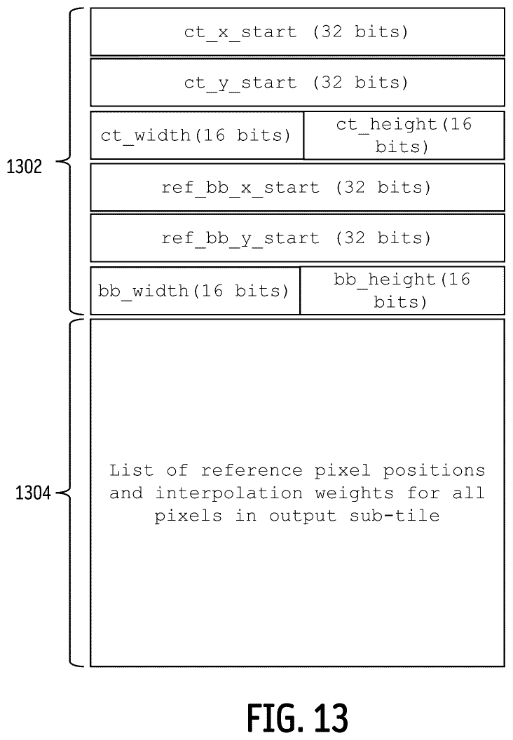

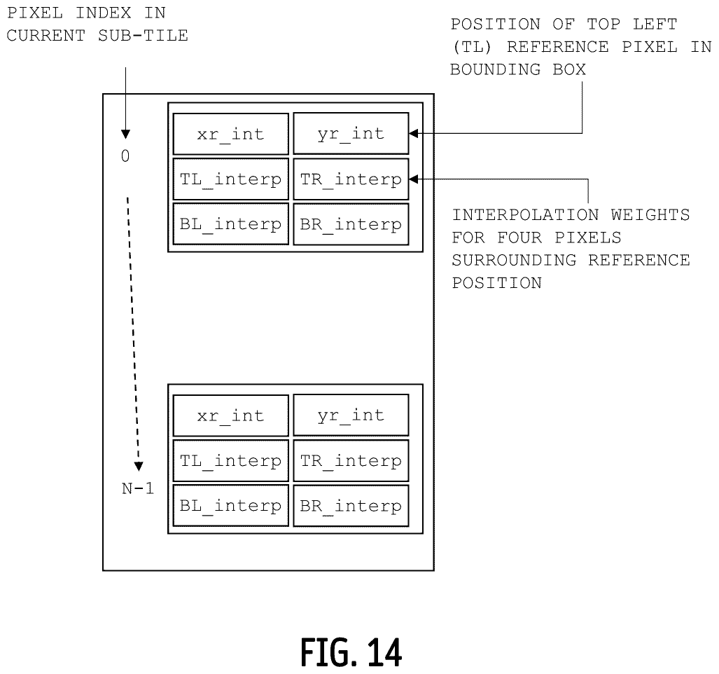

FIGS. 13-14 illustrate metadata for a sub-tile, according to some embodiments of the disclosure. Portion 1302 of the metadata can include the metadata at the sub-tile level shown above. The metadata at the sub-tile level can be used to set up 2D block data transfer between off-chip memory and on-chip memory for the output tile and the reference data corresponding to the sub-tile.

Portion 1304 of the metadata can include per-pixel metadata for the sub-tile, which is shown in greater detail in FIG. 14. FIG. 14 illustrates that per-pixel metadata is collated for each pixel index in the given sub-tile, e.g., from 0 to N−1 if the sub-tile has N pixels.

Example metadata for a pixel in a sub-tile can include the following:

| | |
|---|---|
| xr_int | x index/position/location of top-left reference |
| | pixel in the reference bounding box |
| yr_int | y index/position/location of top-left reference |
| | pixel in the reference bounding box |
| TL_interp | Interpolation weight of the top-left reference |
| | pixel |
| TR_interp | Interpolation weight of the top-right reference pixel |
| BL_interp | Interpolation weight of the bottom-left reference pixel |
| BR_interp | Interpolation weight of the bottom-right reference pixel |

Example pseudocode to generate the metadata illustrated in FIGS. 13-14 can be as follows:

Inputs:
super_tile_x_start: x-coordinate of top-left corner of super
tile
super_tile_y_start: y-coordinate of top-left corner of super
tile
mv_x: HxW array of motion vectors in x direction.
mv_y: HxW array of motion vectors in x direction.
sub_tile: (tile_start_x, tile_start_y, tile_width, tile_height)
sub_tile
Outputs:
sub_tile_metadata: Structure as described herein
Begin:
Initialize coord_x_row = array[0,1,2, ...,W-1]
ct_x_start = super_tile_x_start + tile_start_x
ct_y_start = super_tile_y_start + tile_start_y
ct_width = tile_width
ct_height = tile_height
ref_bb_x_min = MAX_INT
ref_bb_y_min = MAX_INT
ref_bb_x_max = MIN_INT
ref_bb_y_max = MIN_INT
For row in from 0 to H-1 :

Read a row of mv_x and mv_y into row_mv_x, and row_mv_y
ref_coord_x_row = coord_x_row + row_mv_x
ref_coord_x[row] = int(ref_coord_x_row)
frac_x[row] = ref_coord_x_row − int(ref_coord_x_row)
ref_coord_y_row = row_mv_y + row
ref_coord_y[row] = int(ref_coord_y_row)
frac_y[row] = ref_coord_y_row − int(ref_coord_y_row)
// write to sub-tile metadata structure
update xr_int values for all pixels in row using

ref_coord_x[row]

update yr_int values for all pixels in row using

ref_coord_y[row]

update ref_bb_x_min and ref_bb_x_max using

ref_coord_x[row]

update ref_bb_y_min and ref_bb_y_max using

ref_coord_y[row]

update interpolation weight values (tl_interp, tr_interp,

bl_interp, br_interp) for all pixels

in row using frac_x[row] and frac_y[row]

update ref_bb_width using ref_bb_x_min and ref_bb_x_max
update ref_bb_height using ref_bb_y_min and ref_bb_y_max

Description of the Pseudocode

Inputs

| | |
|---|---|
| ∘ | super_tile_x_start, super_tile_y_start: The coordinates of |
| | the top-left corner of the super tile within the video |
| | frame. |
| ∘ | mv_x, mv_y: Two-dimensional arrays (size H×W) having the |
| | motion vectors for each pixel in the x and y directions. |
| ∘ | sub_tile: A tuple describing the sub-tile's position and |
| | size within the super tile: starting x, starting y, width, |
| | and height. |

Outputs

| | |
|---|---|
| ∘ | sub_tile_metadata: A data structure having all the |
| | necessary information for processing the sub-tile, such as |
| | reference bounding box coordinates, per-pixel reference |
| | indices, and interpolation weights. |

Explanation of Operations

0. Initialize Variables

| | |
|---|---|
| ∘ | Create an array of x-coordinates for each column in |
| | the sub-tile. |
| ∘ | Calculate the starting coordinates and size of the |
| | sub-tile within the overall frame. |
| ∘ | Set up variables to track the minimum and maximum x |
| | and y values for the reference bounding box (these |
| | will be updated as you process each pixel). |

1. Process Each Row of the Sub-Tile

| | |
|---|---|
| ∘ | For every row in the sub-tile: |

| | |
|---|---|
| ∘ | Read the corresponding row of motion vectors (x |
| | and y directions). |
| ∘ | For each pixel in the row: |

| | |
|---|---|
| ∘ | Calculate the reference x-coordinate by |
| | adding the motion vector to the pixel's x |
| | position. |
| ∘ | Separate the integer part (for indexing) |
| | and the fractional part (for interpolation) |
| | of the reference x-coordinate. |
| ∘ | Calculate the reference y-coordinate by |
| | adding the motion vector to the pixel's y |
| | position. |
| ∘ | Separate the integer part and fractional |
| | part of the reference y-coordinate. |

| | |
|---|---|
| ∘ | Update the metadata structure for each pixel: |

| | |
|---|---|
| ∘ | Store the integer reference coordinates for |
| | each pixel (used for memory access). |
| ∘ | Update the minimum and maximum x and y |
| | values for the reference bounding box, |
| | based on the reference coordinates. |
| ∘ | Calculate and store the interpolation |
| | weights for each pixel, using the |
| | fractional parts of the reference |
| | coordinates. These weights are used for |
| | feature vector interpolation (top-left, |
| | top-right, bottom-left, bottom-right). |

2. Finalize Reference Bounding Box Dimensions

| | |
|---|---|
| ∘ | After processing all rows, calculate the width and |
| | height of the reference bounding box using the |
| | minimum and maximum x and y values found. |

Summary

This algorithm takes a sub-tile within a video frame and, for
each pixel, determines where its reference data is located
(using motion vectors), how to access it (integer coordinates),
and how to interpolate between reference pixels (using
fractional coordinates and weights). It also calculates the
smallest bounding box that has all the reference pixels needed
for the sub-tile, which helps optimize memory access and data
movement for efficient processing.

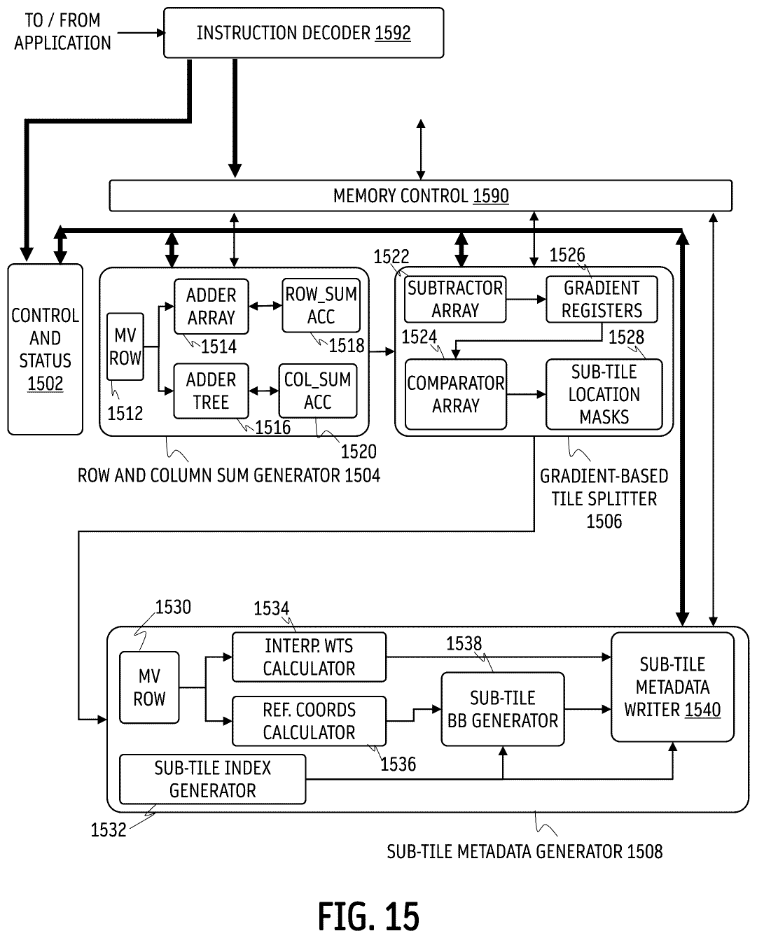

FIG. 15 illustrates micro-architecture for motion vector analysis operations, according to some embodiments of the disclosure. The micro-architecture can include one or more of: instruction decoder 1592, memory control 1590, control and status logic 1502, row and column sum generator 1504, gradient based tile splitter 1506, and sub-tile metadata generator 1508. The micro-architecture can execute operations associated with motion vector information analysis. The micro-architecture can read motion vector information corresponding to a super tile having dimension (e.g., H×W) from on-chip memory as input and splits the super tile into smaller sub-tiles and writes out metadata structures for the sub-tiles.

A host or application can issue one or more specialized instructions to control the execution of the functional blocks of the micro-architecture. Instruction decoder 1592 can decode an instruction set architecture (ISA) comprising one or more specialized instructions and configure the circuitry to perform operations associated with motion vector information analysis. In particular, instruction decoder 1592 can decode the received instruction and configure one or more of control and status logic 1502 and memory control 1590 to execute one or more operations corresponding to the decoded instruction.

The operations corresponding to the decoded instruction being performed by the circuitry can be orchestrated through control and status logic 1502. In some embodiments, control and status logic 1502 can configure the functional blocks to operate either in pipeline mode or in stand-alone mode.

In some embodiments, the host or application can program, via one or more specialized instructions of the ISA, the mode of operation, memory addresses for the inputs and outputs of each functional block (e.g., motion vector tiles as inputs, bounding box metadata as output) and other information like tile width and height. Based on the decoded instruction, control and status logic 1502 can orchestrate the operations of the functional blocks and the timing thereof. Control and status logic 1502 can control feeding of inputs and directing of outputs of the functional blocks. Based on the decoded instruction, memory control 1590 can orchestrate data movement to facilitate execution of the operations.

Row sum and column sum generator 1504 can read motion vector tiles row-wise and update row and column sum accumulators for MV_X and MV_Y tiles. Row sum and column sum generator 1504 can include MV row reader 1512, adder array 1514, adder tree 1516, row sum accumulator registers 1518, and column sum accumulator registers 1520. Row sum accumulator registers 1518 and column sum accumulator registers 1520 can be used for accumulating the element-wise sum of rows and sum of columns. MV row reader 1512 may generate memory address using the start address in control register and a row counter, and reads a row of motion vectors (“MV row”) from on-chip memory in each cycle. Each mv row can have 8 or 16 elements depending upon memory port width and MV precision. Adder array 1514 performs element-wise accumulation of MV row element into row sum accumulator registers 1518. Adder tree 1516 performs sum of all columns in the given MV row and accumulates the sum into the appropriate element of column sum accumulator registers 1520 corresponding to the given row-index. For H,W dimension larger than width of memory port, the accumulation for each row of MV block can be processed in multiple cycles. The design of row sum and column sum generator 1504 is scalable to perform single cycle accumulation by replicating the logical blocks and increasing the memory ports.

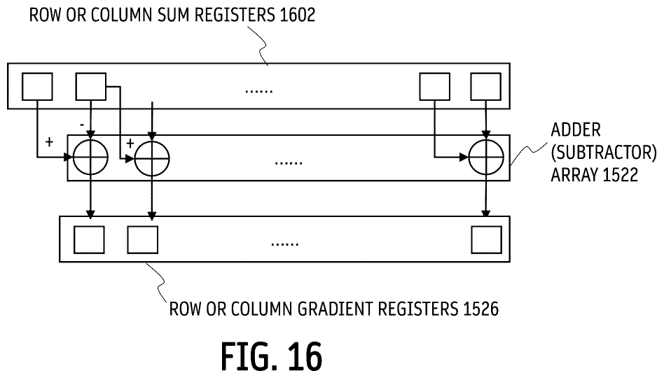

Gradient based tile splitter 1506 may calculate the gradients in the row sum and column sum-vectors of MV_X and MV_Y components. In some embodiments, gradient based tile splitter 1506 can calculate the gradient in a single cycle, using subtractor array 1522. An exemplary implementation of subtractor array 1522 is illustrated in FIG. 16. As illustrated in FIG. 16, subtractor array 1522 can calculate the vector gradient by subtracting consecutive elements from input vector stored in row or column sum registers 1602, and store the results in row or column gradient registers 1526. After calculating the gradient vectors, gradient based tile splitter 1506 can calculate the absolute sum of gradients or row sums from MV_X and MV_Y and chooses the dominant gradient vectors for the vertical direction and the horizonal direction accordingly. The dominant gradient vectors are then fed to comparator array 1524, which performs element-wise comparison with a configurable threshold to decide sub-tile masks 1528 indicating motion boundaries in horizontal and vertical directions.

Sub-tile metadata generator 1508 may include MV row reader 1530 to read the MV_X and MV_Y data, interpolation weights calculator 1534 to generate interpolation weights corresponding to four reference pixels, and reference coordinates calculator 1536 to generate a reference pixel index in local memory. Similar to MV row reader 1512, MV row reader 1530 can read a row of motion vectors (MV_X and MV_Y) from on-chip memory in each cycle. An adder array in reference coordinates calculator 1536 can add MV_X row with column offset row (0,1,2 . . . . W) to calculate the reference x-coordinate (the integer part of the addition). Another adder array of reference coordinates calculator 1536 can add a given row-index to MV_Y row to calculate the reference y-coordinate (the integer part of the addition). Optionally in parallel to coordinate calculation, interpolation weights calculator 1534 can read MV_X and MV_Y rows and extracts the fractional parts of x and y motion vector at each pixel in the given row and calculates the four interpolation weights corresponding to the four reference pixels for each pixel in the sub-tile using the x and y fractions. Sub-tile metadata generator 1508 further includes sub-tile bounding box (BB) generator 1538 to track the reference x and y coordinates for a given pixel in the sub-tile and the corresponding sub-tile index. Generator 1538 may keep updating the BB position and dimensions by tracking the minimum and maximum values of the x and y reference coordinates for each pixel in each sub-tile to form the coordinates and dimensions of the reference bounding box for a given sub-tile.

Sub-tile metadata generator 1508 can include sub-tile index generator 1532 to read the sub-tile x and y location masks from sub-tile masks 1528 and generates the sub-tile identifiers (IDs). Sub-tile index generator 1532 can sum up the sub-tile location mask registers to calculate number sub-tiles in horizontal and vertical directions and total number of sub-tiles. Using this information, sub-tile index generator 1532 calculates the number of pixels in each sub-tile and the offsets for sub-tile metadata writer 1540 to write out the sub-tile metadata for each sub-tile. Sub-tile metadata generator 1508 can include sub-tile metadata writer 1540 that uses the sub-tile IDs to write out the metadata.

The functional blocks of the micro-architecture illustrated in FIG. 15 can be invoked using one or more specialized instructions of the ISA, e.g., to process a rectangular tile of input data.

In some embodiments, MVTLSPLIT represents an instruction to a compute engine to split a super tile into one or more sub-tiles by analyzing x and y components of motion vectors associated with the super tile and write out sub-tile metadata. The input and output are read/written from/to memory. The instruction MVTLSPLIT can be specified as follows:

The format of the instruction is: MVTLSPLIT mvx_ptr, mvy_ptr,
num_rows, num_cols, grad_thresh, sub_tile_info_ptr,
sub_tile_md_ptr.
Inputs: mvx-ptr and mvy-ptr are the addresses of mv-x and mv-y
input tiles (e.g., memory addresses pointing to the tile data),
num_rows and num_cols are number of rows and columns input tile
(e.g., size dimensions of the tile data). The grad_thresh
(e.g., a splitting condition or splitting criteria) is the
threshold of gradients in row and column direction. The tile
gets split wherever the gradient exceeds this threshold
Outputs: sub_tile_info_ptr is the address for writing the list
having the number of total sub-tiles, pixels in each sub-tile
and the offset of metadata for each sub-tile (e.g., memory
address for writing information specifying the sub-tiles). The
sub_tile_md_ptr is address for writing out the list of metadata
structures of each sub-tile (e.g., memory address for writing
metadata corresponding to the super tile and the one or more
sub-tiles therein).

In some embodiments, VELGRAD represents an instruction to a compute engine to calculate a gradient across elements within a vector, e.g., to calculate a gradient on motion vector rows or columns in a tile (e.g., a super tile or a sub-tile) from memory/register to memory/register allowing input and output to be in memory. The instruction VELGRAD can be specified as follows:

The format of the instruction is: VELGRAD in-ptr, num-vec, vec-
len, out-ptr.
Inputs: in-ptr is the memory address pointing to one or more
input vectors, num-vec is the number of input vectors being
processed, and num-vec is the number of elements in an input
vector.
Output: out-ptr is the memory address for writing one or more
gradient vectors.
The in-ptr and out-ptr are addresses of input vectors and
output gradient vectors.
The input and output vectors are stacked.
The hardware uses vec-len (e.g., number of elements in the
input vector) to identify number of elements in each vector and
num-vec (e.g., number of vectors being processed) as number of
vectors.

In some embodiments, RCSUM represents an instruction to a compute engine to summing up all rows and columns, e.g., to calculate row-wise sum-vector and column-wise sum-vector for a tile (e.g., a super tile or a sub-tile) from memory/register to memory/register allowing input and output to be in memory. The instruction RCSUM can be specified as follows:

The format of the instruction is: RCSUM mvx-ptr, mvy-ptr,
num_rows, num_cols, rsum-ptr, csum-ptr.
Inputs: mvx-ptr and mvy-ptr are the memory addresses pointing
to the tile data. num_rows and num_cols are the size dimensions
of the tile data.
Outputs: rsum-ptr and csum-ptr are memory addresses for writing
the row-sum
The mvx-ptr and mvy-ptr are the addresses of mv-x and mv-y
tiles. The rsum-ptr and csum-ptr are addresses of the of row
and column sums.

While the examples described with FIGS. 15-16 relate to using the specialized instructions in the ISA for motion vector information analysis, it is envisioned that the specialized instructions in the ISA can be used for analyzing other types of data beyond motion vector data. The specialized instructions of the ISA can be used to cluster data into rectangular sub-tiles based on gradient analysis or to find boundaries based on gradient analysis to split the data into rectangular sub-tiles having homogeneous data.

In some embodiments, one or more specialized instructions can support operating on data having different precisions, such as 32/16/8/4-bit floating point data.

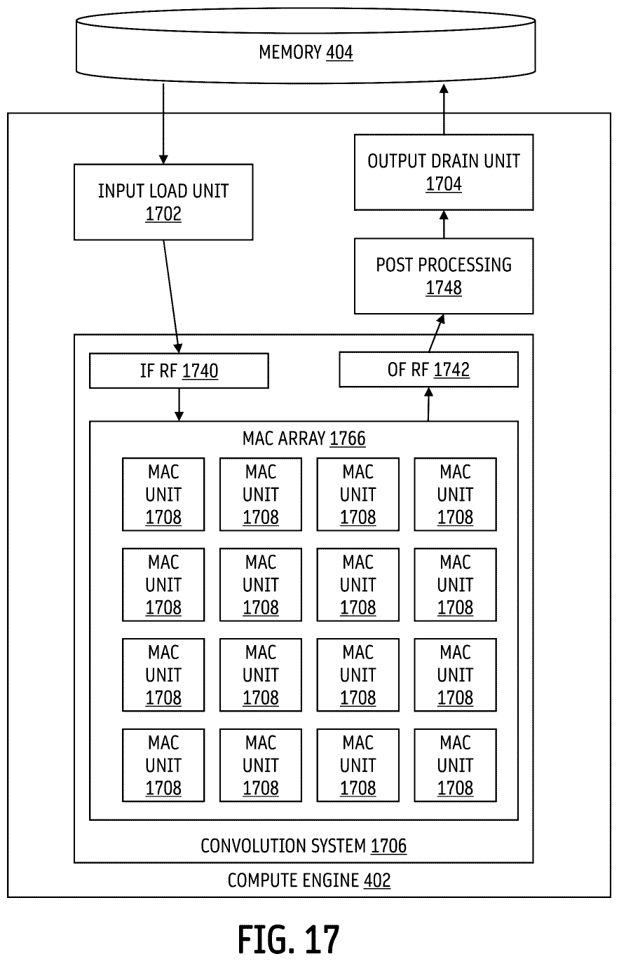

FIG. 17 illustrates components in compute engine 402 interfacing with on-chip memory 404, according to some embodiments of the disclosure. Compute engine 402 may include convolution system 1706 having multiply-and-accumulate (MAC) array 1766. MAC array 1766 may include an array of MAC units 1708 to perform MAC operations (e.g., result=(A×B)+C). In some cases, a MAC unit can process one or more elements. MAC array 1766 be used to perform matrix-to-matrix or matrix-to-vector multiplications. Compute engine 402 may be optimized for executing high-throughput data parallel operations such as matrix multiplication, convolution, applying filter kernels, etc.

Input load unit 1702 of compute engine 402 may load data, such as feature vectors corresponding to the four reference pixels for a given pixel and corresponding interpolation weights from memory 404 and onto input feature register file 1740. Upon performing calculations in convolution system 1706, the output data (e.g., the interpolated feature vector for the pixel) can be written to output feature register file 1742. Optionally, the output data may be processed by post processing 1748, and the output data can be drained to memory 404 by output drain unit 1704. In some embodiments, output drain unit 1704 may perform matrix transposing.

In the context of sub-tile-based grid sampling, compute engine 402 as illustrated in FIG. 17 can be adapted and used to perform feature vector interpolation. In some embodiments, MAC array 1766 can accelerate element-wise add and multiply operations. Internal adders and multipliers of MAC units 1708 of MAC array 1766 can be repurposed to perform feature vector interpolation. For multiplying a vector with scalar (element-wise multiplication with common factor, or in the context of feature vector interpolation, element-wise multiplication of a reference feature vector with an interpolation weight), there is a scale multiplier within a MAC unit of MAC units 1708. The MAC unit of MAC units 1708 can include accumulator logic to perform element-wise addition of two vectors to complete the feature vector interpolation (e.g., element-wise addition of weighted feature vectors together).

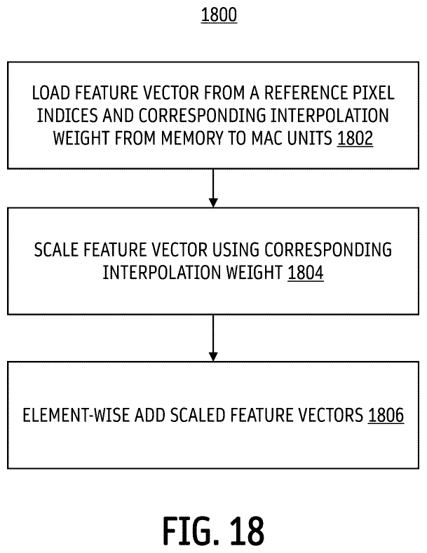

FIG. 18 depicts a flow diagram illustrating method 1800 for performing feature vector interpolation in a multiply-and-accumulate array, according to some embodiments of the disclosure. In 1802, input load unit 1702 of FIG. 17 can, for each pixel in the sub-tile, reads one or more feature vectors from one or more reference pixel indices and corresponding interpolation weights (e.g., scale factors) from memory 404 of FIG. 17 into one or more MAC units 1708 of FIG. 17. As an example, a MAC unit of MAC units 1708 can process four elements. In 1804, one or more MAC unit of MAC units 1708 can scale a feature vector one by one. In 1806, the one or more MAC units can generate the output feature vector for a given pixel using element-wise additions of scaled feature vectors.

### Methods for Sub-Tile-Based Grid Sampling Execution

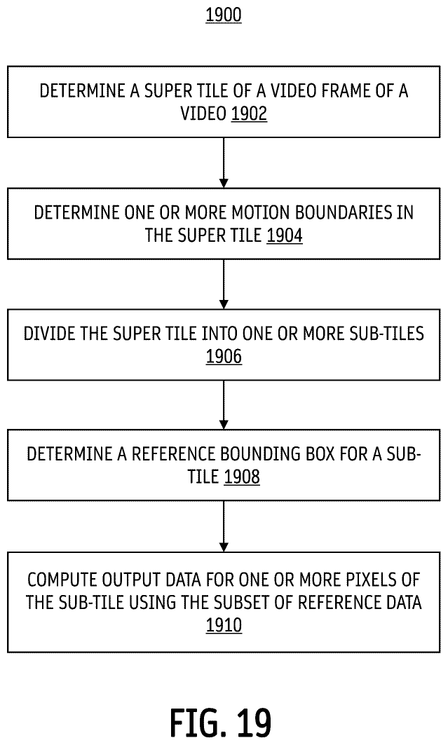

FIG. 19 depicts a flow diagram illustrating method 1900 for sub-tile-based execution of grid sampling, according to some embodiments of the disclosure. Method 1900 can be performed by any one of the components illustrated in FIG. 4.

In 1902, a super tile of a video frame of a video is determined. The super tile represents a rectangular region of the video frame.

In 1904, one or more motion boundaries in the super tile are determined based on motion vector information corresponding to the super tile.

In 1906, the super tile is divided into one or more sub-tiles according to the one or more motion boundaries.

In 1908, a reference bounding box for a sub-tile in the one or more sub-tiles is determined. The reference bounding box limits the reference data for the video frame to a subset of the reference data.

In 1910, a compute engine computes output data for one or more pixels of the sub-tile using the subset of reference data loaded onto a memory for the compute engine based on the reference bounding box.

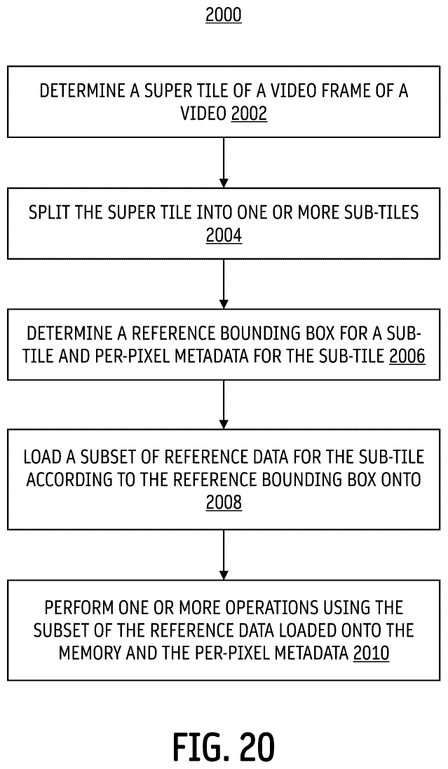

FIG. 20 depicts a flow diagram illustrating method 2000 for sub-tile-based execution of grid sampling, according to some embodiments of the disclosure. Method 2000 can be performed by any one of the components illustrated in FIG. 4.

In 2002, a super tile of a video frame of a video is determined.

In 2004, the super tile is split into one or more sub-tiles.

In 2006, a reference bounding box for a sub-tile and per-pixel metadata for the sub-tile are determined.

In 2008, a subset of reference data for the sub-tile according to the reference bounding box is loaded onto a memory; and

In 2010, one or more operations are performed using the subset of the reference data loaded onto the memory and the per-pixel metadata.

### Exemplary Computing Device

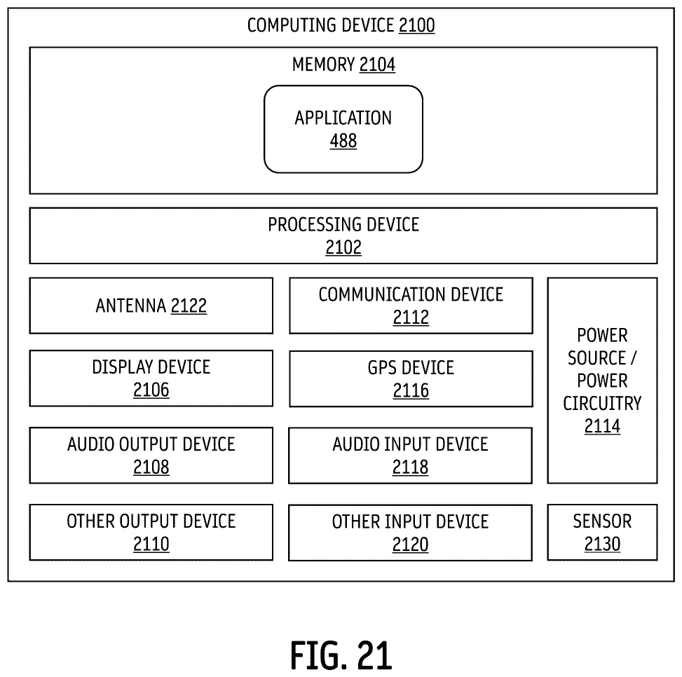

FIG. 21 is a block diagram of an apparatus or a system, e.g., an exemplary computing device 2100, according to some embodiments of the disclosure. One or more computing devices 2100 may be used to implement the functionalities described with the FIGS. and herein. A number of components illustrated in FIG. 21 can be included in the computing device 2100, but any one or more of these components may be omitted or duplicated, as suitable for the application. In some embodiments, some or all of the components included in the computing device 2100 may be attached to one or more motherboards. In some embodiments, some or all of these components are fabricated onto a single SoC die. Additionally, in various embodiments, the computing device 2100 may not include one or more of the components illustrated in FIG. 21, and the computing device 2100 may include interface circuitry for coupling to the one or more components. For example, the computing device 2100 may not include a display device 2106, and may include display device interface circuitry (e.g., a connector and driver circuitry) to which a display device 2106 may be coupled. In another set of examples, the computing device 2100 may not include an audio input device 2118 or an audio output device 2108 and may include audio input or output device interface circuitry (e.g., connectors and supporting circuitry) to which an audio input device 2118 or audio output device 2108 may be coupled.

Computing device 2100 may include a processing device 2102 (e.g., one or more processing devices, one or more of the same types of processing device, one or more of different types of processing device). Processing device 2102 may include electronic circuitry that processes electronic data from data storage elements (e.g., registers, memory, resistors, capacitors, quantum bit cells) to transform that electronic data into other electronic data that may be stored in registers and/or memory. Examples of processing device 2102 may include a CPU, a GPU, a quantum processor, a machine learning processor, an AI processor, a neural network processor, an AI accelerator, an ASIC, an analog signal processor, an analog computer, a microprocessor, a digital signal processor, an FPGA, a tensor processing unit (TPU), a neural network hardware accelerator, an SoC, a DNN accelerator, an NPU, a DNN acceleration circuit, a compute engine, etc.

Computing device 2100 may include a memory 2104, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 2104 includes one or more non-transitory computer-readable storage media. In some embodiments, memory 2104 may include memory that shares a die with the processing device 2102.

In some embodiments, memory 2104 includes one or more non-transitory computer-readable media storing instructions executable to perform operations described with the FIGS. and herein. The instructions stored in the one or more non-transitory computer-readable media may be executed by processing device 2102. Memory 2104 may store instructions that causes processing device 2102 to perform one or more methods described and illustrated herein.

In some embodiments, memory 2104 may store data, e.g., data structures, binary data, bits, metadata, files, blobs, etc., as described with the FIGS. and herein.

In some embodiments, memory 2104 may store one or more DNNs (and or parts thereof). Memory 2104 may store training data for training (trained) a DNN. Memory 2104 may store instructions that perform operations associated with training a DNN. Memory 2104 may store input data, output data, intermediate outputs, intermediate inputs of one or more DNNs. Memory 2104 may store one or more parameters used by the one or more DNNs. Memory 2104 may store information that encodes how nodes of the one or more DNNs are connected with each other. Memory 2104 may store instructions to perform one or more operations of the one or more DNNs. Memory 2104 may store a model definition that specifies one or more operations of a DNN. Memory 2104 may store instructions, such as configuration descriptors, that are generated by a compiler based on the model definition.

In some embodiments, computing device 2100 may include a communication device 2112 (e.g., one or more communication devices). For example, the communication device 2112 may be configured for managing wired and/or wireless communications for the transfer of data to and from the computing device 2100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not have any wires, although in some embodiments they might not. The communication device 2112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2105 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. Communication device 2112 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication device 2112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication device 2112 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication device 2112 may operate in accordance with other wireless protocols in other embodiments. The computing device 2100 may include an antenna 2122 to facilitate wireless communications and/or to receive other wireless communications (such as radio frequency transmissions). Computing device 2100 may include receiver circuits and/or transmitter circuits. In some embodiments, Communication device 2112 may manage wired communications, such as electrical, optical, or any other suitable communication protocols (e.g., the Ethernet). As noted above, the communication device 2112 may include multiple communication chips. For instance, a first communication device 2112 may be dedicated to shorter-range wireless communications such as Wi-Fi or Bluetooth, and a second communication device 2112 may be dedicated to longer-range wireless communications such as global positioning system (GPS), EDGE, GPRS, CDMA, WiMAX, LTE, EV-DO, or others. In some embodiments, a first communication device 2112 may be dedicated to wireless communications, and a second communication device 2112 may be dedicated to wired communications.

Computing device 2100 may include power source/power circuitry 2114. The power source/power circuitry 2114 may include one or more energy storage devices (e.g., batteries or capacitors) and/or circuitry for coupling components of the computing device 2100 to an energy source separate from the computing device 2100 (e.g., DC power, AC power, etc.).

Computing device 2100 may include a display device 2106 (or corresponding interface circuitry, as discussed above). The display device 2106 may include any visual indicators, such as a heads-up display, a computer monitor, a projector, a touchscreen display, a liquid crystal display (LCD), a light-emitting diode display, or a flat panel display, for example.

Computing device 2100 may include an audio output device 2108 (or corresponding interface circuitry, as discussed above). The audio output device 2108 may include any device that generates an audible indicator, such as speakers, headsets, or earbuds, for example.

Computing device 2100 may include an audio input device 2118 (or corresponding interface circuitry, as discussed above). The audio input device 2118 may include any device that generates a signal representative of a sound, such as microphones, microphone arrays, or digital instruments (e.g., instruments having a musical instrument digital interface (MIDI) output).

Computing device 2100 may include a GPS device 2116 (or corresponding interface circuitry, as discussed above). The GPS device 2116 may be in communication with a satellite-based system and may receive a location of the computing device 2100, as known in the art.

Computing device 2100 may include a sensor 2130 (or one or more sensors). Computing device 2100 may include corresponding interface circuitry, as discussed above). Sensor 2130 may sense physical phenomenon and translate the physical phenomenon into electrical signals that can be processed by, e.g., processing device 2102. Examples of sensor 2130 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 2100 may include another output device 2110 (or corresponding interface circuitry, as discussed above). Examples of the other output device 2110 may include an audio codec, a video codec, a printer, a wired or wireless transmitter for providing information to other devices, haptic output device, gas output device, vibrational output device, lighting output device, home automation controller, or an additional storage device.

Computing device 2100 may include another input device 2120 (or corresponding interface circuitry, as discussed above). Examples of the other input device 2120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 2100 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 2100 may be any other electronic device that processes data.

### SELECT EXAMPLES

Example 1 provides an integrated circuit, including a memory to store one or more reference data and motion vector information for one or more video frames of a video; a data movement engine to move data between the memory and a further memory accessible by one or more compute engines; and the one or more compute engines to: determine one or more super tile of a video frame of the video, a super tile representing a rectangular region of the video frame; determine, based on the motion vector information, one or more motion boundaries in the super tile; split the super tile at the one or more motion boundaries into one or more sub-tiles, the one or more of sub-tiles representing one or more rectangular regions of the super tile; and determine a reference bounding box for a sub-tile in the one or more sub-tiles.

Example 2 provides the integrated circuit of example 1, where: the data movement engine is to move a subset of the one or more reference data according to the reference bounding box of the sub-tile from the memory to the further memory; and the one or more compute engines are further to compute output data for one or more pixels of the sub-tile using the subset of the one or more reference data.

Example 3 provides the integrated circuit of example 1 or 2, where: the data movement engine is to move a subset of the motion vector information corresponding to the super tile to the further memory.

Example 4 provides the integrated circuit of any one of examples 1-3, where a size of the super tile is determined based on at least one or more of: the motion vector information, a dimension of reference data associated with the super tile, a precision of the reference data associated with the super tile, and memory availability of the further memory.

Example 5 provides the integrated circuit of example 4, where the motion vector information corresponds to motion vector information of a further video frame of the video processed previously to the video frame.

Example 6 provides the integrated circuit of example 4 or 5, where the motion vector information includes an average of motion vector gradients of the super tile.

Example 7 provides the integrated circuit of any one of examples 1-6, where the one or more motion boundaries in the super tile are determined based on one or more of: a motion vector gradient in a horizontal direction and a further motion vector gradient in a vertical direction.

Example 8 provides the integrated circuit of example 7, where the one or more motion boundaries correspond to at least one or more of: one or more indices where the motion vector gradient in the horizontal direction cross a threshold, and one or more further indices where the motion vector gradient in the vertical direction cross the threshold.

Example 9 provides the integrated circuit of example 7 or 8, where the motion vector gradient in the horizontal direction is determined by: calculating row-wise sum-vector of X-component of motion vectors of the super tile; and calculating an X-component horizontal gradient based on element-wise differences of the row-wise sum-vector.

Example 10 provides the integrated circuit of example 9, where the motion vector gradient in the horizontal direction is further determined by: calculating a further row-wise sum-vector of Y-component of motion vectors of the super tile; calculating a Y-component horizontal gradient based on element-wise differences of the further row-wise sum-vector; and selecting a dominant horizontal gradient from the X-component horizontal gradient and the Y-component horizontal gradient.

Example 11 provides the integrated circuit of any one of examples 7-10, where the further motion vector gradient in the vertical direction is determined by: calculating column-wise sum-vector of X-component of motion vectors of the super tile; and calculating an X-component vertical gradient based on element-wise differences of the column-wise sum-vector.

Example 12 provides the integrated circuit of example 11, where the further motion vector gradient in the vertical direction is further determined by: calculating a further column-wise sum-vector of Y-component of motion vectors of the super tile; calculating a Y-component vertical gradient based on element-wise differences of the further column-wise sum-vector; and selecting a dominant vertical gradient from the X-component vertical gradient and the Y-component vertical gradient.

Example 13 provides the integrated circuit of any one of examples 1-12, where the one or more compute engines further determine, for a pixel of the sub-tile in the one or more sub-tiles, a memory index corresponding to reference data associated with a reference pixel in the reference bounding box.

Example 14 provides the integrated circuit of any one of examples 1-13, where the one or more compute engines further determine, for a pixel of the sub-tile in the one or more sub-tiles, one or more interpolation weights corresponding to one or more reference pixels in the reference bounding box.

Example 15 provides the integrated circuit of example 13 or 14, where the one or more compute engines load one or more reference data using the memory index corresponding to reference data associated with the reference pixel in the reference bounding box.

Example 16 provides the integrated circuit of example 14 or 15, where the one or more compute engines are to: receive the one or more interpolation weights corresponding to the one or more reference pixels in the reference bounding box; and perform computation using reference data associated with the one or more reference pixels and the one or more interpolation weights.

Example 17 provides an integrated circuit, including a memory; a processor coupled to the memory, the processor to determine a super tile of a video frame of a video, split the super tile into one or more sub-tiles, and determine a reference bounding box for a sub-tile of the one or more sub-tiles and per-pixel metadata for the sub-tile; a data movement engine to load a subset of reference data for the sub-tile according to the reference bounding box onto the memory; and a compute array coupled to the memory, the compute array to perform one or more operations using the subset of reference data loaded onto the memory and the per-pixel metadata and output data for the sub-tile based on the one or more operations.

Example 18 provides the integrated circuit of example 17, where the compute array performs one or more operations for a plurality of pixels of the sub-tile in parallel.

Example 19 provides the integrated circuit of example 17 or 18, where the compute array performs the one or more operations by performing feature vector interpolation for one or more pixels of the sub-tile using the per-pixel metadata.

Example 20 provides the integrated circuit of any one of examples 17-19, where the per-pixel metadata includes a memory index corresponding to reference data associated with a reference pixel in the reference bounding box.

Example 21 provides the integrated circuit of example 20, where a load unit of the compute array loads the reference data associated with the reference pixel using the memory index.

Example 22 provides the integrated circuit of any one of examples 17-21, where the per-pixel metadata includes one or more interpolation weights corresponding to one or more reference pixels in the reference bounding box.

Example 23 provides the integrated circuit of example 22, where a load unit of the compute array loads the one or more interpolation weights onto one or more processing units of the compute array.

Example 24 provides a method, including determining one or more super tiles of a video frame of a video, a super tile representing a rectangular region of the video frame; determining, based on motion vector information corresponding to the super tile, one or more motion boundaries in the super tile; dividing the super tile into one or more sub-tiles according to the one or more motion boundaries; determining a reference bounding box for a sub-tile in the one or more sub-tiles, the reference bounding box limiting reference data for the video frame to a subset of the reference data; and computing, by a compute engine, output data for one or more pixels of the sub-tile using the subset of the reference data loaded onto a memory for the compute engine based on the reference bounding box.

Example 25 provides the method of example 24, where determining the super tile includes determining a size of the super tile based on at least one or more of: the motion vector information, a dimension the reference data associated with the super tile, a precision of the reference data associated with the super tile, and memory availability of the memory for the compute engine.

Example 26 provides the method of example 25, where the motion vector information corresponds to motion vector information of a further video frame of the video processed prior to the video frame.

Example 27 provides the method of example 25 or 26, where the motion vector information includes an average of motion vector gradients of the super tile.

Example 28 provides the method of any one of examples 24-27, where determining the one or more motion boundaries in the super tile includes determining a motion vector gradient in a horizontal direction and a further motion vector gradient in a vertical direction.

Example 29 provides the method of example 28, where determining the one or more motion boundaries includes determining at least one or more of: one or more indices where the motion vector gradient in the horizontal direction cross a threshold, and one or more further indices where the motion vector gradient in the vertical direction cross the threshold.

Example 30 provides the method of example 28 or 29, where determining the motion vector gradient in the horizontal direction includes calculating row-wise sum-vector of X-component of motion vectors of the super tile; and calculating an X-component horizontal gradient based on element-wise differences of the row-wise sum-vector.

Example 31 provides the method of example 30, where determining the motion vector gradient in the horizontal direction further includes calculating a further row-wise sum-vector of Y-component of motion vectors of the super tile; calculating a Y-component horizontal gradient based on element-wise differences of the further row-wise sum-vector; and selecting a dominant horizontal gradient from the X-component horizontal gradient and the Y-component horizontal gradient.

Example 32 provides the method of any one of examples 28-31, where determining the further motion vector gradient in the vertical direction includes calculating column-wise sum-vector of X-component of motion vectors of the super tile; and calculating an X-component vertical gradient based on element-wise differences of the column-wise sum-vector.

Example 33 provides the method of example 32, where determining the further motion vector gradient in the vertical direction further includes calculating a further column-wise sum-vector of Y-component of motion vectors of the super tile; calculating a Y-component vertical gradient based on element-wise differences of the further column-wise sum-vector; and selecting a dominant vertical gradient from the X-component vertical gradient and the Y-component vertical gradient.

Example 34 provides the method of any one of examples 24-33, further including determining, for a pixel of the sub-tile in the one or more sub-tiles, a memory index corresponding to reference data associated with a reference pixel in the reference bounding box.

Example 35 provides the method of any one of examples 24-34, further including determining, for a pixel of the sub-tile in the one or more sub-tiles, one or more interpolation weights corresponding to one or more reference pixels in the reference bounding box.

Example 36 provides the method of example 34 or 35, further including loading reference data for the pixel of the sub-tile using the memory index corresponding to the reference data associated with the reference pixel in the reference bounding box.

Example 37 provides the method of example 35 or 36, where computing the output data includes receiving the one or more interpolation weights corresponding to the one or more reference pixels in the reference bounding box; and perform computation using the reference data associated with the one or more reference pixels and the one or more interpolation weights.

Example 38 provides a method, including determining a super tile of a video frame of a video; splitting the super tile into one or more sub-tiles; determining a reference bounding box for a sub-tile of the one or more sub-tiles and per-pixel metadata for the sub-tile; loading a subset of reference data for the sub-tile according to the reference bounding box for the sub-tile onto a memory; and performing one or more operations using the subset of reference data loaded onto the memory and the per-pixel metadata.

Example 39 provides the method of example 38, further including outputting data for the sub-tile based on the one or more operations.

Example 40 provides the method of example 38 or 39, where performing the one or more operations includes performing the one or more operations for a plurality of pixels of the sub-tile in parallel.

Example 41 provides the method of any one of examples 38-40, where

performing the one or more operations includes performing feature vector interpolation for one or more pixels of the sub-tile using the per-pixel metadata.

Example 42 provides the method of any one of examples 38-41, where the per-pixel metadata includes a memory index corresponding to reference data associated with a reference pixel in the reference bounding box.

Example 43 provides the method of example 42, further including loading reference data associated with the reference pixel using the memory index.

Example 44 provides the method of any one of examples 38-43, where the per-pixel metadata includes one or more interpolation weights corresponding to one or more reference pixels in the reference bounding box.

Example 45 provides the method of example 44, further including loading the one or more interpolation weights onto one or more processing units of a compute array performing the one or more operations.

Example 46 provides a compute engine, including an instruction decoder to decode one or more instructions, including an instruction to split a super tile of a video frame into one or more sub-tiles based on data corresponding to the super tile, the instruction including one or more inputs including one or more memory addresses pointing to the data corresponding to the super tile, one or more size dimensions of the data corresponding to the super tile, and a criterion; and one or more outputs including a memory address for writing information specifying the one or more sub-tiles, and a memory address for writing metadata corresponding to the super tile and the one or more sub-tiles; and circuitry configurable by the instruction decoder to perform one or more operations corresponding to the instruction, the one or more operations include splitting the super tile into one or more sub-tiles based on the data corresponding to the super tile and the criterion and calculating the metadata corresponding to the super tile and the one or more sub-tiles.

Example 47 provides the compute engine of example 46, where: the one or more instructions further include a further instruction to calculate a gradient across elements within a vector, the further instruction including one or more further inputs including a memory address pointing to the vector, a number of elements in the vector; and a further output including a memory address for writing a gradient vector of the vector; and the circuitry is further configurable by the instruction decoder to perform one or more further operations corresponding to the further instruction, the one or more further operations include calculating the gradient vector by subtracting consecutive elements of the vector.

Example 48 provides the compute engine of example 46 or 47, where: the one or more instructions further include a yet further instruction to calculate a row-wise sum-vector and a column-wise sum-vector of data corresponding to the super tile, the yet further instruction including one or more yet further inputs including one or more memory addresses pointing to the data corresponding to the super tile, and one or more size dimensions of the data corresponding to the super tile; and one or more yet further outputs including a memory address for writing the row-wise sum-vector, and a memory address for writing the column-wise sum-vector; and the circuitry is further configurable by the instruction decoder to perform one or more yet further operations corresponding to the yet further instruction, the one or more yet further operations include summing elements of the data corresponding to the super tile along each row and summing elements of the data corresponding to the super tile down each column.

Example 49 provides a method, including decoding an instruction to split a super tile into one or more sub-tiles based on data corresponding to the super tile, the instruction including one or more inputs including one or more memory addresses pointing to the data corresponding to the super tile, one or more size dimensions of the data corresponding to the super tile, and a criteria; and one or more outputs including a memory address for writing information specifying the one or more sub-tiles, and a memory address for writing metadata corresponding to the super tile and the one or more sub-tiles; and based on the instruction, configuring processing circuitry to split the super tile into one or more sub-tiles based on the data corresponding to the super tile and the criteria and calculate the metadata corresponding to the super tile and the one or more sub-tiles.

Example 50 provides the method of example 49, further including decoding a further instruction to calculate a gradient across elements within a vector, the further instruction including one or more further inputs including a memory address pointing to the vector, a number of elements in the vector; and a further output including a memory address for writing a gradient vector of the vector; and based on the further instruction, configuring the processing circuitry to calculate the gradient vector by subtracting consecutive elements of the vector.

Example 51 provides the method of example 49 or 50, where: decoding a yet further instruction to calculate a row-wise sum-vector and a column-wise sum-vector of data corresponding to the super tile, the yet further instruction including one or more yet further inputs including one or more memory addresses pointing to the data corresponding to the super tile, and one or more size dimensions of the data corresponding to the super tile; and one or more yet further outputs including a memory address for writing the row-wise sum-vector, and a memory address for writing the column-wise sum-vector; and based on the yet further instruction, configuring the processing circuitry to sum elements of the data corresponding to the super tile along each row and sum elements of the data corresponding to the super tile down each column.

Example A provides an apparatus comprising means for performing a method according to any one of examples 24-45 and 49-51.

Example B provides a computer program product comprising instructions which, when executed by a processor, cause the processor to perform a method according to any one of examples 24-45 and 49-51.

Example C provides machine-readable storage including machine-readable instructions, when executed, cause a computer to implement a method according to any one of examples 24-45 and 49-51.

Example D provides a computer program comprising instructions which, when the computer program is executed by a processing device, cause the processing device to carry out a method according to any one of examples 24-45 and 49-51.

Example E provides a computer-implemented system, comprising one or more processors, and one or more non-transitory computer-readable media storing instructions that, when executed by the one or more processors, cause the one or more processors to perform a method according to any one of examples 24-45 and 49-51.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges. For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second thresholds are set in a manner so that both statements result in the same logical outcome for any value of A. For the purposes of the present disclosure, “B is greater than a first threshold” is equivalent to “B is greater than or equal to a second threshold” provided that the first threshold and the second thresholds are set in a manner so that both statements result in the same logical outcome for any value of B.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An integrated circuit, comprising:
a memory to store one or more reference data and motion vector information for one or more video frames of a video;
a data movement engine to move data between the memory and a further memory accessible by one or more compute engines; and
the one or more compute engines to:
determine one or more super tile of a video frame of the video, a super tile representing a rectangular region of the video frame;
determine, based on the motion vector information, one or more motion boundaries in the super tile;
split the super tile at the one or more motion boundaries into one or more sub-tiles, the one or more of sub-tiles representing one or more rectangular regions of the super tile; and
determine a reference bounding box for a sub-tile in the one or more sub-tiles.

2. The integrated circuit of claim 1, wherein:
the data movement engine is to move a subset of the one or more reference data according to the reference bounding box of the sub-tile from the memory to the further memory; and
the one or more compute engines are further to compute output data for one or more pixels of the sub-tile using the subset of the one or more reference data.

3. The integrated circuit of claim 1, wherein:
the data movement engine is to move a subset of the motion vector information corresponding to the super tile to the further memory.

4. The integrated circuit of claim 1, wherein a size of the super tile is determined based on at least one or more of: the motion vector information, a dimension of reference data associated with the super tile, a precision of the reference data associated with the super tile, and memory availability of the further memory.

5. The integrated circuit of claim 4, wherein the motion vector information corresponds to motion vector information of a further video frame of the video processed previously to the video frame.

6. The integrated circuit of claim 4, wherein the motion vector information comprises an average of motion vector gradients of the super tile.

7. The integrated circuit of claim 1, wherein the one or more motion boundaries in the super tile are determined based on one or more of: a motion vector gradient in a horizontal direction and a further motion vector gradient in a vertical direction.

8. The integrated circuit of claim 7, wherein the one or more motion boundaries correspond to at least one or more of: one or more indices where the motion vector gradient in the horizontal direction cross a threshold, and one or more further indices where the motion vector gradient in the vertical direction cross the threshold.

9. The integrated circuit of claim 7, wherein the motion vector gradient in the horizontal direction is determined by:
calculating row-wise sum-vector of X-component of motion vectors of the super tile; and
calculating an X-component horizontal gradient based on element-wise differences of the row-wise sum-vector.

10. The integrated circuit of claim 9, wherein the motion vector gradient in the horizontal direction is further determined by:
calculating a further row-wise sum-vector of Y-component of motion vectors of the super tile;
calculating a Y-component horizontal gradient based on element-wise differences of the further row-wise sum-vector; and
selecting a dominant horizontal gradient from the X-component horizontal gradient and the Y-component horizontal gradient.

11. The integrated circuit of claim 1, wherein the one or more compute engines further determine, for a pixel of the sub-tile in the one or more sub-tiles, a memory index corresponding to reference data associated with a reference pixel in the reference bounding box.

12. The integrated circuit of claim 1, wherein the one or more compute engines further determine, for a pixel of the sub-tile in the one or more sub-tiles, one or more interpolation weights corresponding to one or more reference pixels in the reference bounding box.

13. An integrated circuit, comprising:
a memory;
a processor coupled to the memory, the processor to determine a super tile of a video frame of a video, split the super tile into one or more sub-tiles, and determine a reference bounding box for a sub-tile of the one or more sub-tiles and per-pixel metadata for the sub-tile;
a data movement engine to load a subset of reference data for the sub-tile according to the reference bounding box onto the memory; and
a compute array coupled to the memory, the compute array to perform one or more operations using the subset of reference data loaded onto the memory and the per-pixel metadata and output data for the sub-tile based on the one or more operations.

14. The integrated circuit of claim 13, wherein the compute array performs one or more operations for a plurality of pixels of the sub-tile in parallel.

15. The integrated circuit of claim 13, wherein the compute array performs the one or more operations by performing feature vector interpolation for one or more pixels of the sub-tile using the per-pixel metadata.

16. The integrated circuit of claim 13, wherein the per-pixel metadata comprises a memory index corresponding to reference data associated with a reference pixel in the reference bounding box, and one or more interpolation weights corresponding to one or more reference pixels in the reference bounding box.

17. The integrated circuit of claim 16, wherein a load unit of the compute array loads the reference data associated with the reference pixel using the memory index and loads the one or more interpolation weights onto one or more processing units of the compute array.

18. A compute engine, comprising:
an instruction decoder to decode one or more instructions, comprising an instruction to split a super tile of a video frame into one or more sub-tiles based on data corresponding to the super tile, the instruction comprising:
one or more inputs including one or more memory addresses pointing to the data corresponding to the super tile, one or more size dimensions of the data corresponding to the super tile, and a criterion; and
one or more outputs including a memory address for writing information specifying the one or more sub-tiles, and a memory address for writing metadata corresponding to the super tile and the one or more sub-tiles; and
circuitry configurable by the instruction decoder to perform one or more operations corresponding to the instruction, the one or more operations comprise: splitting the super tile into one or more sub-tiles based on the data corresponding to the super tile and the criterion and calculating the metadata corresponding to the super tile and the one or more sub-tiles.

19. The compute engine of claim 18, wherein:
the one or more instructions further include a further instruction to calculate a gradient across elements within a vector, the further instruction comprising:
one or more further inputs including a memory address pointing to the vector, a number of elements in the vector; and
a further output including a memory address for writing a gradient vector of the vector; and
the circuitry is further configurable by the instruction decoder to perform one or more further operations corresponding to the further instruction, the one or more further operations comprise calculating the gradient vector by subtracting consecutive elements of the vector.

20. The compute engine of claim 18, wherein:
the one or more instructions further include a yet further instruction to calculate a row-wise sum-vector and a column-wise sum-vector of data corresponding to the super tile, the yet further instruction comprising:
one or more yet further inputs including one or more memory addresses pointing to the data corresponding to the super tile, and one or more size dimensions of the data corresponding to the super tile; and
one or more yet further outputs including a memory address for writing the row-wise sum-vector, and a memory address for writing the column-wise sum-vector; and
the circuitry is further configurable by the instruction decoder to perform one or more yet further operations corresponding to the yet further instruction, the one or more yet further operations comprise summing elements of the data corresponding to the super tile along each row and summing elements of the data corresponding to the super tile down each column.
